(19) United States
(12) Patent Application Publication
(10) Pub. No.: US 2026/0007963 A1
(43) Pub. Date: Jan. 8, 2026

(54) PROGRAM, INFORMATION PROCESSING SYSTEM, AND INFORMATION PROCESSING METHOD

(71) Applicant: CYGAMES, INC., Tokyo (JP)

(72) Inventors: Satoshi Akitake, Tokyo (JP); Tomohiro Hasegawa, Tokyo (JP); Akisato Marumo, Tokyo (JP); Tetsu Izawa, Tokyo (JP); Hiroshi Yoshioka, Tokyo (JP); Masaru Kubo, Tokyo (JP)

(73) Assignee: CYGAMES, INC., Tokyo (JP)

(21) Appl. No.: 19/323,612

(22) Filed: Sep. 9, 2025

Related U.S. Application Data
(63) Continuation of application No. PCT/JP2024/014792, filed on Apr. 12, 2024.

(30) Foreign Application Priority Data
Apr. 25, 2023 (JP) 2023-071516

(51) Int. Cl. A63F 13/45; A63F 13/52; A63F 13/798; A63F 13/86

(52) U.S. Cl. CPC A63F 13/45; A63F 13/52; A63F 13/798; A63F 13/86

(57) ABSTRACT

Provided are a program, an information processing system, and an information processing method that make it possible to stimulate motivation for participation of players in a wide variety of categories. Included are: a first-stage control unit that controls the progress of a main stage, in which records of individual players are evaluated on the basis of rank points accumulated through repeated races; and a second-stage control unit that controls the progress of an extra stage, in which players with superior records in the main stage are allowed to participate and the players allowed to participate play battles. The second-stage control unit makes it possible to watch a race in the extra stage irrespective of whether or not participation in the extra stage is allowed and makes it possible to acquire a reward on the basis of watching the race.

### CROSS-REFERENCE TO RELATED APPLICATIONS

This application is a continuation of International Patent Application No. PCT/JP2024/014792, having an international filing date of Apr. 12, 2024, which designated the United States, the entirety of which is incorporated herein by reference. Japanese Patent Application No. 2023-071516 filed on Apr. 25, 2023 is also incorporated herein by reference in its entirety.

### BACKGROUND OF THE INVENTION

The present invention relates to programs, information processing systems, and information processing methods for a game in which a plurality of players participate and play a battle.

There have hitherto been games such as: a horse racing game for raising a character based on a racehorse serving as a motif and letting the raised character play a battle in a race with other characters; and a baseball game for raising a character based on a baseball player serving as a motif and letting the raised character participate in a game and play a battle. For example, there is an existing information processing system that provides a battle function with which players who attained a prescribed result in a preliminary round are allowed to participate in a race in a final round (see Publication of Japanese Patent No. 7126578).

With the existing battle function, it is difficult for novice players to advance to the final round, and thus there is a concern that motivation for participation might be eventually lost. Furthermore, advanced players do not feel a sense of freshness about opponents they are matched with in the final race, and thus there is a concern that motivation for participation might be eventually lost.

### SUMMARY OF THE INVENTION

The present invention has been made in view of the situation described above, and it is an object thereof to provide a program, an information processing system, and an information processing method that can serve to stimulate the motivation for players to participate in a wide variety of categories.

According to a first aspect of the disclosure, there is provided a program for a game in which a plurality of players participate and play battles, the program causing a computer to function as:
a first-stage control unit that controls the progress of a first stage, in which records of individual players are evaluated on the basis of evaluation scores updated through repeated battles; and
a second-stage control unit that controls the progress of a second stage, in which players with superior records in the first stage are allowed to participate and the players allowed to participate play battles,
wherein the second-stage control unit makes it possible to watch a battle in the second stage irrespective of whether or not participation in the second stage is allowed and makes it possible to acquire a reward on the basis of watching the battle.

According to a second aspect of the disclosure, there is provided an information processing system for a game in which a plurality of players participate and play battles, the information processing system comprising:
a first-stage control unit that controls the progress of a first stage, in which records of individual players are evaluated on the basis of evaluation scores updated through repeated battles; and
a second-stage control unit that controls the progress of a second stage, in which players with superior records in the first stage are allowed to participate and the players allowed to participate play battles,
wherein the second-stage control unit makes it possible to watch a battle in the second stage irrespective of whether or not participation in the second stage is allowed and makes it possible to acquire a reward on the basis of watching the battle.

According to a third aspect of the invention, there is provided an information processing method for a game in which a plurality of players participate and play battles, wherein a computer is caused to execute:
a first-stage control step of controlling the progress of a first stage, in which records of individual players are evaluated on the basis of evaluation scores updated through repeated battles; and
a second-stage control step of controlling the progress of a second stage, in which players with superior records in the first stage are allowed to participate and the players allowed to participate play battles, and
in the second-stage control step, it is allowed to watch a battle in the second stage irrespective of whether or not participation in the second stage is allowed, and it is allowed to acquire a reward on the basis of watching the battle.

### BRIEF DESCRIPTION OF DRAWINGS

FIG. 1 is a diagram showing the hardware configuration of an information processing system.

FIG. 2 is a functional block diagram of a server in the information processing system.

FIG. 3 is a figure showing an event-parameter update setting table and an event-skill setting table.

FIG. 4 is a functional block diagram of a player terminal in the information processing system.

FIG. 5 is a figure for explaining an overview of battle race events.

FIG. 6 is a figure showing a flow of progress of a main stage in a battle race event.

FIG. 7 is an illustration showing an example event top screen displayed at the player terminal.

FIG. 8 is an illustration showing an example participating-character confirmation dialog displayed at the player terminal.

FIG. 9 is an illustration showing an example skill acquisition rendition executed at the player terminal.

FIG. 10 is an illustration showing an example participation preparation dialog displayed at the player terminal.

FIG. 11 is an illustration showing an example participation preparation dialog displayed at the player terminal.

FIG. 12 is an illustration showing an example participation preparation dialog displayed at the player terminal.

FIG. 13 is an illustration showing an example participation confirmation dialog displayed at the player terminal.

FIG. 14 is an illustration showing an example home screen displayed at the player terminal.

FIG. 15 is an illustration showing a scene in a race video displayed at the player terminal.

FIG. 16 is an illustration showing an example displaying of rendition concerning a participation reward, executed at the player terminal.

FIG. 17 is an illustration showing an example set end screen displayed at the player terminal.

FIG. 18 is an illustration showing an example rank promotion rendition executed at the player terminal.

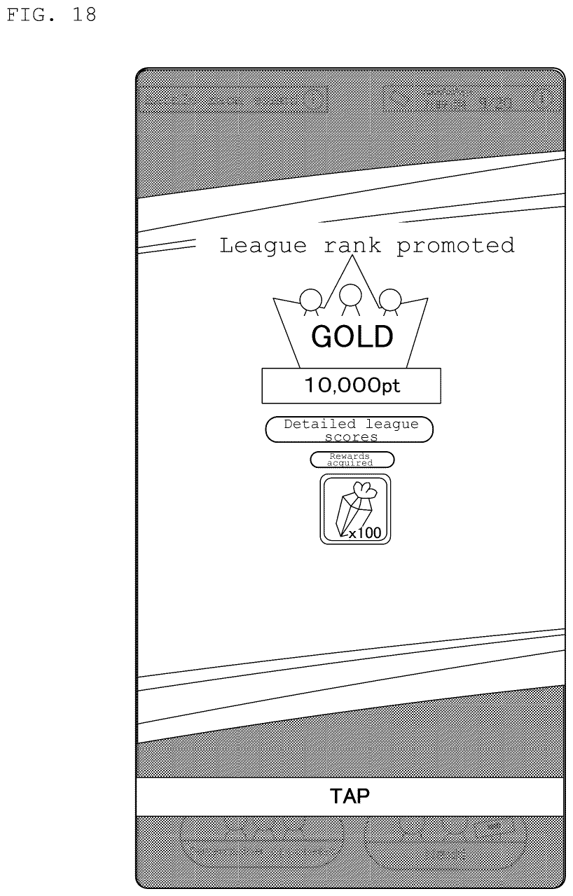

FIG. 19 is an illustration showing an example designated-character selection dialog displayed at the player terminal.

FIG. 20 is an illustration showing an example designated-character confirmation dialog displayed at the player terminal.

FIG. 21 is a figure showing a flow of progress concerning preparation for holding an extra stage in a battle race event.

FIG. 22 is an illustration showing an example ranking announcement dialog displayed at the player terminal.

FIG. 23 is a figure showing a flow of progress of the extra stage in the battle race event.

FIG. 24 is an illustration showing an example event top screen displayed at the player terminal.

FIG. 25 is an illustration showing an example participation registration screen displayed at the player terminal.

FIG. 26 is an illustration showing an example participation registration confirmation dialog displayed at the player terminal.

FIG. 27 is an illustration showing an example EX-stage participation reward dialog displayed at the player terminal.

FIG. 28 is an illustration showing an example event top screen displayed at the player terminal.

FIG. 29 is an illustration showing an example race list screen displayed at the player terminal.

FIG. 30 is an illustration showing an example race list screen displayed at the player terminal.

FIG. 31 is an illustration showing an example rooting-reward reception dialog displayed at the player terminal.

FIG. 32 is an illustration showing an example race replay confirmation dialog displayed at the player terminal.

FIG. 33 is an illustration showing a scene in a race-watching video of a state immediately before the start, displayed at the player terminal.

FIG. 34 is an illustration showing an example camera setting dialog displayed at the player terminal.

FIG. 35 is an illustration showing an example rendition for displaying a list of participating characters, executed at the player terminal.

FIG. 36 is an illustration showing a scene in a race video displayed at the player terminal.

FIG. 37 is an illustration showing an example race-result display screen displayed at the player terminal.

FIG. 38 is an illustration showing an example rendition of rooting subject processing executed at the player terminal.

FIG. 39 is an illustration showing an example race-watching reward receiving dialog displayed at the player terminal.

### DETAILED DESCRIPTION OF THE INVENTION

(1) The present embodiment relates to a program for a game in which a plurality of players participate and play battles, the program causing a computer to function as: a first-stage control unit that controls the progress of a first stage, in which records of individual players are evaluated on the basis of evaluation scores updated through repeated battles; and a second-stage control unit that controls the progress of a second stage, in which players with superior records in the first stage are allowed to participate and the players allowed to participate play battles, wherein the second-stage control unit makes it possible to watch a battle in the second stage irrespective of whether or not participation in the second stage is allowed and makes it possible to acquire a reward on the basis of watching the battle.

(2) In the present embodiment, the arrangement may be such that when a battle in the second stage is watched, the second-stage control unit accepts an input for selecting, as a subject for a specific indication, an arbitrary game medium from among game media registered by a plurality of players who participate in the battle, and displays a watching screen in which it is possible to identify the game medium selected as the subject for the specific indication.

(3) In the present embodiment, the arrangement may be such that the second-stage control unit makes it possible to acquire a reward on the basis of having selected the subject for the specific indication.

(4) The present embodiment relates to an information processing system for a game in which a plurality of players participate and play battles, the information processing system including: a first-stage control unit that controls the progress of a first stage, in which records of individual players are evaluated on the basis of evaluation scores updated through repeated battles; and a second-stage control unit that controls the progress of a second stage, in which players with superior records in the first stage are allowed to participate and the players allowed to participate play battles, wherein the second-stage control unit makes it possible to watch a battle in the second stage irrespective of whether or not participation in the second stage is allowed and makes it possible to acquire a reward on the basis of watching the battle.

(5) The present embodiment relates to an information processing method for a game in which a plurality of players participate and play battles, wherein a computer is caused to execute: a first-stage control step of controlling the progress of a first stage, in which records of individual players are evaluated on the basis of evaluation scores updated through repeated battles; and a second-stage control step of controlling the progress of a second stage, in which players with superior records in the first stage are allowed to participate and the players allowed to participate play battles, and
in the second-stage control step, it is allowed to watch a battle in the second stage irrespective of whether or not participation in the second stage is allowed, and it is allowed to acquire a reward on the basis of watching the battle.

With the program, information processing system, and information processing method of the embodiment described above, players with superior records in the first stage are allowed to participate in battles in the second stage, which makes it possible for the players who have advanced to the second stage to receive proper evaluations for their abilities. Meanwhile, with the program, information processing system, and information processing method of the present embodiment, it is allowed to watch a battle in the second stage irrespective of whether or not participation in the second stage is allowed, and it is allowed to acquire a reward on the basis of watching the battle. Thus, it is possible to give a motivation for watching a battle in the second stage to players who have not advanced to the second stage for the purpose of acquiring the reward. As described above, the program, information processing system, and information processing method of the present embodiment make it possible to stimulate motivation for participation of players in a wide range of categories.

An embodiment of the present invention will be described below. It is to be noted that the embodiment described below does not unduly limit the content of the invention recited in the claims. Furthermore, it is not necessarily the case that all the features described in the context of this embodiment are necessary features required in the present invention.

### 1. Configuration of Information Processing System

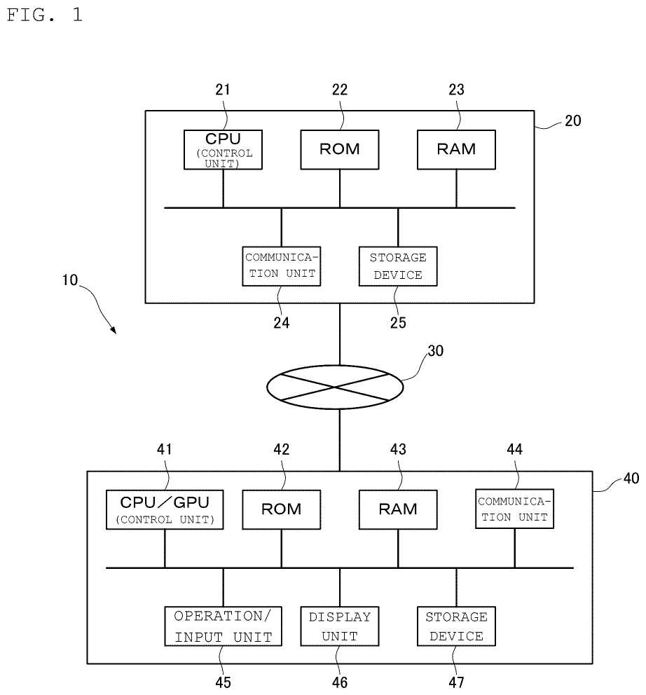

FIG. 1 is a diagram showing an example overall hardware configuration of an information processing system 10 according to this embodiment. In the information processing system 10 according to this embodiment, a server 20 and a player terminal 40 are connected via a network 30 such as the Internet, a mobile phone network, a LAN, or a WAN, whereby what is called a client-server communication system is constructed.

The server 20 includes a CPU 21 (control unit), a ROM 22, a RAM 23, a communication unit 24, and a storage device 25.

The CPU 21 reads out programs and data stored in the ROM 22 and executes various kinds of processing. The RAM 23 is used as temporary storage areas such as a main memory and a work area of the CPU 21. The communication unit 24, which is implemented by a communication module or a communication interface, carries out processing for communication with the player terminal 40 or other external devices via the network 30. The storage device 25, which is an auxiliary storage device such as a flash memory, an HDD, or an SDD, stores programs concerning a game, identification information such as an ID of a player who uses the player terminal 40, and other various kinds of per-player information necessary for the game.

The player terminal 40, which is a device for playing the game according to this embodiment, is, for example, a smartphone, a tablet, a personal computer, a mobile game machine, or an installed game machine installed at an establishment or a household. The player terminal 40 includes a CPU/GPU 41 (control unit), a ROM 42, a RAM 43, a communication unit 44, an operation/input unit 45, a display unit 46, and a storage device 47.

The CPU/GPU 41 reads out programs and data stored in the ROM 42 into the RAM 43 and executes various kinds of processing. The ROM 42 stores programs necessary for the operation of the player terminal 40. A flash memory (NVRAM) may be adopted instead of the ROM 42. The RAM 43 is used as temporary storage areas such as a main memory and a work area of the CPU/GPU 41. The communication unit 44, which is implemented by a communication module or a communication interface, carries out processing for communication with the server 20 or other external devices (including other player terminals 40) via the network 30. The operation/input unit 45, which is a device for accepting various kinds of operations and inputs by the player, corresponds to a touch panel, a keyboard, a microphone, or the like. Note that in the case where the display unit 56 is a display panel equipped with a touch panel, the touch panel is included in the operation/input unit 45. The display unit 46 is a liquid crystal display or an organic EL display that displays various kinds of information such as images of the game provided by the information processing system 10 in this embodiment. The storage device 47, which is an auxiliary storage device such as a flash memory, an HDD, or an SDD, mainly stores programs concerning the game, various kinds of data relating to the game, etc.

The functions of and processing by the player terminal 40 are realized by the CPU/GPU 41 reading out programs stored in the ROM 22 or the storage device 47 and executing the programs. Alternatively, the CPU/GPU 41 may read out programs stored in a recording medium removable from the player terminal 40 and may execute the programs. Furthermore, the form of providing the player terminal 40 with programs may be a computer-readable recording medium having the programs recorded therein, such as a CD-ROM, or a transmission medium through which the programs are transmitted, such as the Internet. This embodiment will be described while assuming that the player terminal 40 is a smartphone that includes a display panel equipped with a touch panel.

The information processing system 10 in this embodiment has a function for providing, via the player terminal 40, a game of raising a character (an example game medium) based on a racehorse serving as a motif and letting the raised character participate in a race to compete with other characters. The information processing system 10 in this embodiment has functions such as a raising function for raising a character and a battle function for letting a raised character play a battle with other characters in a race. The following describes the case where the raising function and the battle function are realized mainly by the player terminal 40. However, the functions mentioned above may be realized mainly by the server 20 or may be realized in a manner shared by the server 20 and the player terminal 40.

Furthermore, as the battle function, the information processing system 10 in this embodiment can provide battle race events that are held during limited periods. Each battle race event is arranged such that a main stage (an example of the first stage) and an extra stage (EX stage: an example of the second stage) are provided and such that players with superior results in the main stage can advance to the extra stage.

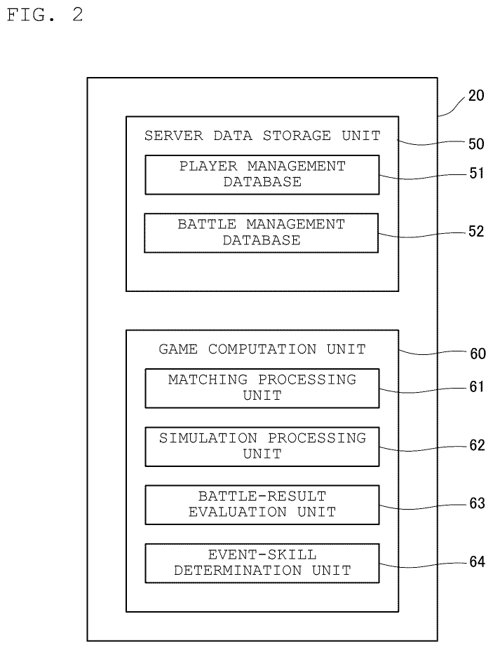

FIG. 2 is a functional block diagram showing main functions of the server 20.

The server 20 in the information processing system 10 has a function for managing players, characters, etc. on the basis of various kinds of identification information and a function for carrying out computations necessary for the progress of the game in response to a request from the player terminal 40 and transmitting the result of the computation to the player terminal 40. These functions are realized through cooperation between a server data storage unit 50 and a game computation unit 60.

The server data storage unit 50 includes a player management database 51 and is mainly realized by the storage device 25. In this embodiment, character lists, item lists, raising subject lists, etc. are stored in the player management database 51 in association with player IDs, which are assigned on a per-player basis.

A character list includes, for example, character individual IDs assigned to individual raised characters, character kind IDs indicating the kinds of the characters, the statuses (rarity, evaluation score, course aptitude, distance suitability, running style suitability, race strategy, speed, stamina, power, spirit, wisdom, possessed skills, acquired titles, and factor information) of the characters, the lock states (locked or not locked), raising histories (raising conditions (character-to-inherit selection information and support-item configuration information) and the records of races participated in during raising) of the characters, etc.

In this embodiment, a “raised character” refers to a character that has been raised by means of the raising function, which is one of the game functions realized by the information processing system 10 in this embodiment, and whose statuses have been fixed as a result of completion of the raising thereof.

Furthermore, “character individual IDs” and “character kind IDs” are provided in this embodiment, which differ from each other as follows.

First, a “character individual ID” is an ID that is assigned when the raising of a character by means of the raising function has been finished and the resulting raised character is registered in a character list. “Character individual IDs” are used to identify individual raised characters associated with a player ID.

Furthermore, in this embodiment, the arrangement is such that the player selects a raising subject from a plurality of kinds of characters with the raising functions. “Character kind IDs” are IDs that are assigned in order to identify the kind of a raising subject character.

Furthermore, the “lock state” indicates whether or not transfer (deletion from a character list) of a raised character is prohibited. Transfer is permitted if the raised character is not locked, and transfer is not permitted if the raised character is locked. Situations in which a raised character becomes locked include the case where the player has individually specified the raised character from a list of raised characters, the case where the raised character is registered for participation in a race, etc.

A raising subject list stores data in which information indicating released or not yet released is associated with each character kind ID. In this embodiment, characters having information indicating released associated therewith in the raising subject list serve as characters that can be selected as a raising subject by a player with the raising function. Furthermore, in this embodiment, it is possible to newly release a character with a releasing item or through a character acquiring lottery, and the number of characters that can be selected as a raising subject varies among players. Hereinafter, there are cases where characters that can be selected as a raising subject with the raising function are referred to as released characters.

An item list includes data concerning items, enhancement points, trainer points (TPs), and an in-game currency possessed by a player. In this embodiment, for example, the content and number of items possessed, the amount of enhancement points possessed, the amount of trainer points (TPs) possessed, the amount of the in-game currency possessed, etc. are stored in the player management database 51 in the form of an item list.

An item in this embodiment, for example, supports raising of a character or is used for purposes such as changing conditions for participating in a race. An item can be acquired depending on the result of a race or can be acquired by consuming the in-game currency.

Furthermore, enhancement points are used, for example, for purposes such as enhancing a support item, which is an item for supporting raising of a character. It becomes possible to raise a character in a more advantageous environment as a support item is enhanced.

Meanwhile, trainer points (TPs) are points used for raising a character by using the raising function. When starting raising, it is possible to start raising of a character by consuming trainer points (TPs) corresponding to an amount of consumption necessary for one raising occasion.

Factor information is information that is associated with a raised character in the case where a character has been raised with the raising function. In this embodiment, when a character is raised with the raising function, on the basis of factor information associated with raised characters selected as characters to inherit, a factor inheritance event occurs as a game event for reinforcing statuses that influence abilities of the raising subject character, such as increasing a skill acquisition level or increasing a performance parameter.

Factor information includes four lineages, namely, blue factors, red factors, unique factors, and white factors. Each item of factor information has a factor level set to one of three levels, and an effect more advantageous for status reinforcement is acquired as the factor level becomes higher. Furthermore, factor types specifically classify blue factors, red factors, unique factors, and white factors. A blue factor is factor information having the name of a performance parameter and influences the performance parameter, and the amount of increase in the performance parameter becomes greater as the factor level becomes higher. A red factor is factor information having the name of a course suitability, a distance suitability, or a running style suitability and influences the course aptitude, the distance suitability, or the running style suitability, and the suitability is more likely to increase in a factor inheritance event as the factor level becomes higher. A unique factor is factor information having the name of a unique skill and makes it possible to acquire a unique skill of an inherited character, and it becomes easier to increase the acquisition level of the unique skill as the factor level becomes higher. The acquisition level of a skill influences the amount of skill points consumed when acquiring the skill, and the amount of skill points consumed decreases as the acquisition level becomes higher. A white factor is factor information that does not belong to any of blue factors, red factors, and unique factors, and white factors include skill factors, race factors, and scenario factors. A skill factor is factor information having the name of a skill and makes it easier to increase the acquisition level of a normal skill (a skill that is not a unique skill), and skill factors exist for individual kinds of skills. A race factor is factor information having the name of a race and makes it easier to increase at least one of a performance parameter and the acquisition level of a normal skill, and the effect thereof varies depending on the kind of the race. A scenario factor is factor information having the name of a raising scenario and is factor information relating to a raising scenario used to raise a character. In the case where a scenario factor is inherited in a factor inheritance event, it is possible to considerably increase a plurality of performance parameters, and the performance parameters that are increased vary depending on the kind of the scenario factor. Furthermore, according to the factor types mentioned earlier, factor information is classified into six types, namely, blue factors, red factors, unique factors, skill factors, race factors, and scenario factors.

Furthermore, the server data storage unit 50 includes a battle management database 52, and data concerning battle race events are stored in the battle management database 52. For example, the data stored includes data concerning the holding schedules of battle race events, an event-parameter update setting table, a rank-point acquisition setting table, an event-skill setting table, an event-skill lottery table, a reward setting table, matching IDs for identifying races, the player IDs of players participating in battle race events, the character individual IDs of raised characters registered by players for participation in battle race events, the records (the numbers of participations, places, etc.) of players in battle race events, players' statuses of acquisition of an event parameter and statuses of acquisition of rank points (the total amounts of rank points acquired by players and the total amounts of rank points acquired for individual kinds of characters), the league ranks of players, and the numbers of participation tickets possessed by players.

An event parameter (an example of a specific parameter) is a parameter necessary for the acquisition of an event skill. In the case of participation in a race in the main stage in a race battle event, an event parameter corresponding to the result of the race is calculated with reference to the event-parameter update setting table. Upon the completion of one set (five races), the player who requested participation in the races is notified of the content of updating of the event parameter for the one set. The arrangement may be such that the event parameter is updated on a per-race basis and such that the event parameter value acquired is displayed each time the result of each race is displayed at the player terminal 40.

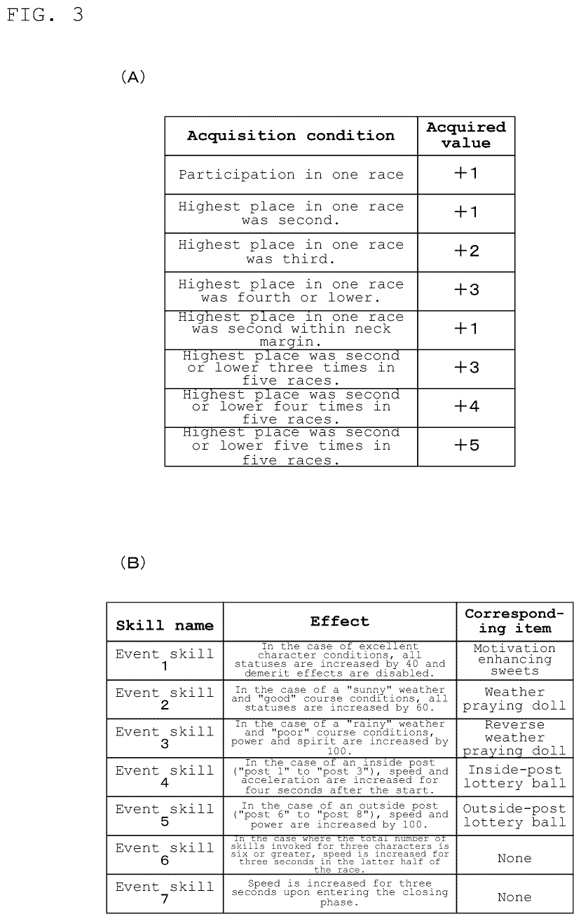

Part (A) in FIG. 3 is a figure showing an example event-parameter update setting table. In the event-parameter update setting table, relationships between acquisition conditions corresponding to race results and values of the event parameter to be acquired are set according to evaluation criteria (an example of prescribed evaluation criteria) that the evaluation becomes higher (the amount of update of the event parameter becomes greater) as the superiority of the battle result becomes lower. As an example, settings are made such that the event parameter value to be acquired is greater in the case where the highest place was the third place than in the case where the highest place was the second place. As another example, settings are made such that the event parameter value to be acquired is greater in the case where the highest place was the second place or lower four times in five races constituting one set than in the case where the highest place was the second place or lower three times in five races constituting one set. In this embodiment, the total of the values of the event parameter acquired in five races constituting one set is used as the amount of update of the event parameter. Note that the evaluation criteria for determining the values of the event parameter to be acquired can be set depending on the kind of game. As an example, in a game in which the outcome of a battle is determined on the basis of scores, such as a baseball game or a football game, the event-parameter update setting table can be set such that the value of the event parameter to be acquired by the loser becomes greater as the score difference between the winner and the loser becomes greater. As another example, in a game in which the remaining physical energy of characters that play a battle affects the outcome, such as a combat game or other action games, the event-parameter update setting table can be set such that the event parameter value to be acquired by the loser becomes greater as the difference in remaining physical energy between the winner and the loser becomes greater. As another example, in a game in which the outcome of a battle is determined on condition of winning a prescribed number of points, the event-parameter update setting table can be set such that the event parameter value to be acquired by the loser becomes greater as the difference in the number of points won between the winner and the loser becomes greater.

Furthermore, in the event-parameter update setting table, the event parameter value corresponding to the race result is set such that the event parameter can be acquired additionally in the case where the battle result was a narrow defeat. In this embodiment, the result is determined as a narrow defeat in the case where the character winning the first place was not the character of the player and the character of the player won the second place by a narrow margin with respect to the character winning the first place, such as by a nose, by a head, or by a neck, and an event parameter value can be acquired additionally. Note that the determination criterion concerning a narrow defeat can be set depending on the kind of game. As an example, in a game in which the outcome of a battle is determined on the basis of scores, such as a baseball game or a football game, the result can be determined as a narrow defeat in the case where the score difference between the winner and the loser was a narrow margin (e.g., one point). As another example, in a game in which the remaining physical energy of characters that play a battle affects the outcome, such as a combat game or other action games, the result can be determined as a narrow defeat in the case where the difference in remaining physical energy between the winner and the loser was a narrow margin (e.g., less than 10% of the maximum energy). As another example, in a game in which the outcome of a battle is determined on condition of winning a prescribed number of points, the result can be determined as a narrow defeat in the case where the difference in the number of points won between the winner and the loser was a narrow margin (e.g., one point).

Furthermore, in the event-parameter update setting table, there is a setting that makes it possible to acquire an event parameter value on the acquisition condition of participation in one race, which makes it possible to acquire an event parameter value of “+1” or greater in each of five races constituting one set.

Regarding an event skill (an example of a special effect), in the case where the event parameter has reached a maximum value (e.g., 30: an example of a prescribed value), an event skill randomly determined from among a plurality of kinds of event skills is set to the player for whom the event parameter has reached the maximum value. A player who has acquired an event skill can invoke the effect of the event skill in five races constituting one set in the main stage. In the case where an event skill has been acquired, the event parameter is reset to an initial value (e.g., 0). Although this embodiment will be described in the context of the case where an event skill is set in association with a player, an event skill may be set in association with a team while considering three raised characters that participate in a race as one team, or an event skill may be set individually in association with each raised character that participates in a race.

Part (B) in FIG. 3 is a figure showing an event-skill setting table. In this embodiment, seven kinds of event skills, namely, event skill 1 to event skill 7, are prepared, and effects corresponding to the kinds of skills are set. Furthermore, the event skills include event skills whose invocation is affected by race conditions (motivation, weather, course conditions, and post position) that can be arbitrarily changed by the player by using items. Specifically, the invocation of event skill 1 is affected by the motivation, the invocation of event skill 2 and event skill 3 is affected by the weather and the course conditions, and the invocation of event skill 4 and event skill 5 is affected by the post position. Thus, for event skill 1 to event skill 5, event-skill corresponding items relating to the satisfaction of an invocation condition (an example of a specific condition) are set. Meanwhile, as for event skill 6 and event skill 7, since the invocation conditions for these skills are not affected by the use of items, event-skill corresponding items are not set.

The rank points (an example of an evaluation score) are a parameter for setting a league rank for the player in the main stage, and rank points corresponding to the race result are granted on each participation in a race in the main stage. The rank points are referred to in matching processing in the main stage, and the player is matched with another player having a league rank close to that of the player himself or herself as an opponent. Furthermore, the rank points are used in ranking players after the end of the main-stage holding period, and players whose ranks based on the rank points satisfy a condition for participating in the extra stage are allowed to participate in races in the extra stage. In a rank-point acquisition setting tables, the values of rank points corresponding to places in races are set according to an evaluation criterion (an example of another evaluation criterion) such that the evaluation becomes higher (the amount of rank points to be acquired becomes greater) as the superiority of the battle result becomes higher.

The league rank is information that serves as an index concerning candidates of the opponent in the main stage, and the arrangement is such that the league rank becomes higher when the rank points satisfy a promotion condition. As the league rank, four kinds are provided, namely, bronze, silver, gold, and platinum, and it is possible to acquire a rank-up reward when the league rank is promoted.

The game computation unit 60 executes processing for performing computations necessary for the progress of the game in response to requests from the player terminal 40 and transmitting computation results to the player terminal 40, processing for transmitting data necessary for the progress of the game to the player terminal 40 in response to requests from the player terminal 40, etc. The game computation unit 60 is realized mainly by the CPU 21 and the communication unit 24. As an example, when a request concerning a training instruction has been received from the player terminal 40 with the raising function, the game computation unit 60 computes the result of the training, indicating either a success or a failure, and transmits the computation result to the player terminal 40. As another example, when a request concerning participation in a race has been received with the raising function, the game computation unit 60 performs a race simulation with a plurality of characters including a raising subject character and non-player characters (NPCs) and transmits the result of the race simulation to the player terminal 40. As another example, when a request concerning participation in a race has been received with the battle function, the game computation unit 60 performs a race simulation with a plurality of characters including a raised character configured by the player and a raised character configured by an opponent and transmits the result of the race simulation to the player terminal 40.

The game computation unit 60 includes a matching processing unit 61. The matching processing unit 61 performs processing for determining an opponent for a player who has finished registering characters in a battle race event. In the information processing system 10 in this embodiment, in the main stage of the battle race event, it becomes possible to perform an input for a matching request (matching input) when the registration of three characters has been finished. When a matching input has been performed at the player terminal 40 of a player who participates in the main stage, a matching request is transmitted from the player terminal 40 to the server 20. In response to the matching request from the player terminal 40, the matching processing unit 61 creates a player list by extracting other players who serve as candidates of the opponents and randomly extracts other players who serve as the opponents in five races (one player for each race) constituting one set from the player list. More specifically, the matching processing unit 62 extracts one hundred players to create a player list in which other players who possess rank points within a prescribed range with reference to the rank points of the player who has performed an input for determining the opponents are sorted in order of log-in. Five players extracted from the player list are allocated to five races constituting one set, and a matching ID that is shared among the five players and race IDs for identifying races in which the five opponent players participate are assigned. The race IDs of the five players are associated with the matching ID to create a new battle record in the battle management database 52. The battle record has recorded therein battle histories (opponents, participating characters, places, times, etc.) of the individual five races constituting one set in a battle race event.

Furthermore, the matching processing unit 61 performs gate lotteries for the five races constituting one set in the main stage in order to allocate participant numbers for twelve characters in total, including six characters (three characters×2) registered for participation by two players in total, namely, the players who requested a battle and the opponent, as well as six non-player characters (hereinafter abbreviated as NPCs as necessary). In the gate lotteries, one of the participant numbers “1” to “12” is allocated to each of the characters such that there are no duplicates. In simulation processing, which will be described later, a race simulation is performed that twelve characters start a race from positions arranged in order of the participant numbers from the inner side of the course used in the race.

Furthermore, the matching processing unit 61 performs condition lotteries for determining race conditions for the five races constituting one set in the main stage. In this embodiment, the weather (randomly selected from four kinds, namely, sunny, cloudy, rainy, and snowy) and the course condition (randomly selected from four kinds, namely, good, slightly heavy, heavy, and poor) are determined through the condition lotteries. The race conditions determined through the condition lotteries are applied commonly to the five races constituting one set, and in simulation processing, which will be described later, a race simulation is performed while applying the race conditions determined through the condition lotteries.

Furthermore, in the information processing system 10 in this embodiment, for the extra stage in a battle race event, opponents are determined on the basis of ranks based on the total rank points that individual players have acquired in the main stage. The matching processing unit 61 performs player matching by allocating the top 96 players in the main stage, i.e., the players who participate in the extra stage, four players per race according to the ranks based on rank points, to 24 races in total, namely, the first race to the twelfth race for block A and the first race to the twelfth race for block B, and creates a battle record corresponding to the individual races in the battle management database 52.

The game computation unit 60 includes a simulation processing unit 62. In the main stage of a battle race event, for each of the five races constituting one set, the simulation processing unit 62 performs a race simulation with twelve characters in total, including six raised characters (three characters×2) registered for participation by two players, as well as six non-player characters (NPCs). Furthermore, in the extra stage of a battle race event, for each of 24 races in total, namely, the first race to the twelfth race for block A and the first race to the twelfth race for block B, the simulation processing unit 62 performs a race simulation with twelve raised characters (three characters×4) registered for participation by four players. In each race simulation, computations concerning the race development, the running speeds, the amounts of stamina consumption, skill invocation lotteries, skill invocation condition checks, places, times, etc. are performed on the basis of the statuses (speed, stamina, power, spirit, wisdom, course suitability, distance aptitude, running style suitability, race strategy, and possessed skills) of the individual characters. In particular, in this embodiment, in the case where participation in a race is requested by a player who has acquired an event skill in the main stage and the invocation condition for the event skill is satisfied, the simulation processing unit 62 executes a race simulation in which the event skill is applied to each of the three raised characters registered for participation by that player. The results of race simulations executed in the main stage and the extra stage of each battle race event are recorded in a battle record created in the battle management database 52.

Furthermore, in the information processing system 10 in this embodiment, the server 20 transmits information indicating the results of various kinds of processing to the player terminal 40, such as the results of matching performed by the matching processing unit 61 and the results of race simulations by the simulation processing unit 62. Furthermore, in the information processing system 10 in this embodiment, the player terminal 40 makes it possible to watch how the race goes via the display unit 46 on the basis of the information indicating the results of various kinds of processing, received from the server 20.

The game computation unit 60 includes a battle-result evaluation unit 63. When a battle through a race has been performed in the main stage of a race battle event, the battle-result evaluation unit 63 calculates the amount of rank points acquired corresponding to the race results of the raised characters of the player who requested participation in the race with reference to the rank-point acquisition setting table stored in the battle management database 52, and transmits information indicating the calculated amount of rank points acquired to the player terminal 40 of the player who requested participation in the race. In this embodiment, the rank points of individual players are managed in association with player IDs in the battle management database 52, and the league ranks of individual players are determined on the basis of the rank points. Furthermore, the battle-result evaluation unit 63 grants participation rewards to players for participation in races in the main stage, and grants rank-up rewards to players whose rank points have satisfied a condition for promoting the league rank. Furthermore, the battle-result evaluation unit 63 ranks individual players on the basis of the rank points in the main stage, and allows players whose ranks based on the rank points satisfy a condition for participating in the extra stage at the end of the holding period of the main stage to participate in a battle in the extra stage. Note that, instead of the rank points, the criterion for assessing the records of individual players in the main stage when determining players who participate in the extra stage may be the number of victories in the main stage or the fastest time in a plurality of races in the main stage. That is, the evaluation score for assessing the records of each player in the main stage may be the number of victories or a time as well as the rank points already mentioned.

Furthermore, the battle-result evaluation unit 63 aggregates the rank points acquired for each kind of character in the main stage on a per-player basis and records the total amount of rank points acquired in association with the player ID and the character kind ID in the battle management database 52. In this embodiment, the total amount of rank points acquired for each kind of character is used in checking a condition for enabling the selection of an event-specific title granted as a reward in a battle race event. In this embodiment, each player is allowed to set a title for himself or herself. The title set for each player is displayed together with the player name in a display screen for confirming information concerning the player. The title set for a player is displayed, for example, to other players registered as friends or other players who participate in the same race by using the battle function. A title signifies the accomplishment of a condition for acquiring the title, and a player can advertise his or her own achievements in the game to other players by using the title set by himself or herself. Furthermore, a title is an index indicating achievements in the game and basically does not affect the progress of races or the game. With some game functions, however, it is possible to utilize titles in processing for extracting players having a prescribed title by using the possession of the title as a criterion for determination.

Furthermore, when a battle through a race is performed in the main stage in the holding period of the main stage of a race battle event, the battle-result evaluation unit 63 determines the amount of updating the event parameter, corresponding to the race result, with reference to the event-parameter acquisition setting table stored in the battle management database 52, and updates the event parameter of the player who requested participation in the race so that the event parameter becomes closer to the maximum value among the event parameters stored in the battle management database 52 and managed on a per-player basis. The event parameter may be updated so as to become remoter from the maximum value in the case where the race result is a prescribed result. For example, the event-parameter acquisition setting table has set therein an event-parameter subtraction value for the case where the results of the five races constituting one set in the main stage were victories (a raised character registered for participation by the player won the first place) in all the five races, which enables the battle-result evaluation unit 63 to perform updating so that the event parameter of a player who won in all the five races constituting one set becomes remoter from the maximum value.

The game computation unit 60 includes an event-skill determination unit 64. The event-skill determination unit 64 sets an event skill that is advantageous for a battle to a player whose total value of the event parameter has reached the maximum value. In this embodiment, the event parameter is updated in the case where five races constituting one set have been finished in the main stage. In the case where the updated event parameter has reached the maximum value, the event-skill determination unit 64 executes a lottery with reference to the event-skill lottery table stored in the battle management database 52 and transmits information concerning the event skill determined through the lottery to the player terminal 40 of the participating player whose event parameter has reached the maximum value.

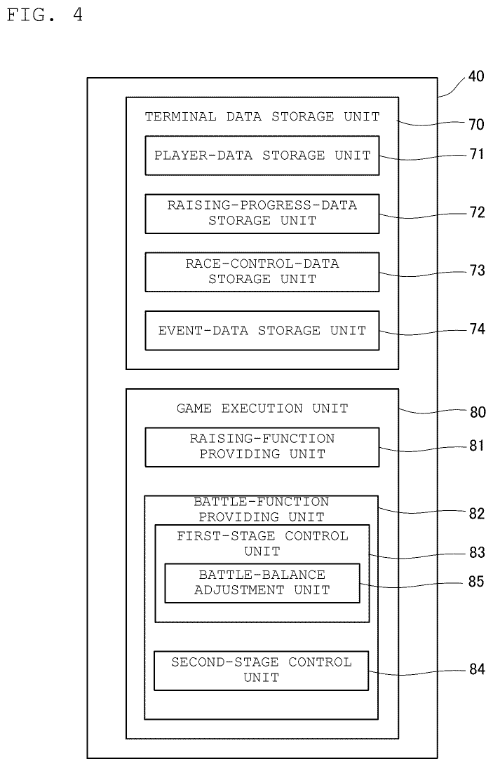

FIG. 4 is a functional block diagram showing main functions of the player terminal 40.

In the player terminal 40 in the information processing system 10 in this embodiment, as shown in FIG. 3, a terminal data storage unit 70 and a game execution unit 80 cooperate to realize the raising function and the battle function.

The terminal data storage unit 70 stores data for the game execution unit 80 to execute various kinds of processing and is mainly realized by the storage device 47.

The terminal data storage unit 70 includes a player-data storage unit 71. The player-data storage unit 71 stores data concerning a character list, a raising subject list, an item list, a friend list, etc. associated with the player ID. In this embodiment, when an application is started and is closed and in other necessary situations, synchronization processing concerning the data associated with the player ID (the character list, the raising subject list, the item list, the friend list, etc.) is performed between the player-data storage unit 71 of the player terminal 40 and the player management database 51 of the server 20, and various kinds of game processing are executed by using the data stored in the player-data storage unit 71. In this embodiment, in the case where it has become necessary to change the character list, the raising subject list, the item list, or the friend list as various kinds of game processing are executed, the content stored in the player-data storage unit 71 is updated, and the updated stored content is backed up in the player management database 51 of the server 20, whereby the content stored is synchronized therebetween. Alternatively, the arrangement may be such that the data associated with the player ID, such as the character list, the raising subject list, the item list, and the friend list, are downloaded from the player management database 51 to the player-data storage unit 71 as needed when, for example, an application is started.

The terminal-data storage unit 70 includes a raising-progress-data storage unit 72. The raising-progress-data storage unit 72 stores data (raising progress data) necessary for the progress, with the raising function, of characters that can be selected as a raising subject with the raising function (characters having character kind IDs associated with information indicating released in the raising subject list). In this embodiment, raising targets, game events, etc. are prepared for individual characters in relation to the raising function, and raising progress data at least including the content of settings of the raising target and the content of settings of the game event is stored in the game-progress-data storage unit 72 in association with character kind IDs.

Furthermore, the terminal data storage unit 70 includes a race-control-data storage unit 73. The race-control-data storage unit 73 stores data for controlling the rendition of character actions, skill invocations, etc. when presenting a race in which a character participates with the raising function or the battle function, text data and audio data for live race commentary, etc.

Furthermore, the terminal data storage unit 70 includes an event-data storage unit 74. The event-data storage unit 74 stores various kinds of data for performing control concerning battle race events. In this embodiment, the event-data storage unit 74 stores data concerning the schedule for holding battle race events, data for managing the number of participation tickets possessed, data for managing the event parameter associated with the player ID, data concerning the invocation conditions and effects of event skills, data for generating display screens and images concerning dialogs, data for managing the status of acquisition of rewards, etc.

The game execution unit 80 performs processing including: processing for starting the game in the case where a game start condition is satisfied; processing for executing a game mode selected from among a plurality of kinds of game modes; processing for letting the game progress; processing for generating an event in the case where an event generation condition is satisfied; processing for computing a game result; processing for terminating the game in the case where a game termination condition is satisfied; processing for requesting computation to the server 20; processing for obtaining a computation result or necessary data from the server 20; and processing for transmitting a computation result or data at the player terminal 40 to the server 20. The game execution unit 80 is realized mainly by the CPU/GPU 41 and the communication unit 44. In this embodiment, the game execution unit 80 includes a raising-function providing unit 81 and a battle-function providing unit 82.

The raising-function providing unit 81 performs processing for providing the raising function for raising a character. In this embodiment, inputs concerning raising of a character are accepted, and the results of computations for the inputs are displayed or otherwise used.

In this embodiment, when raising a character with the raising function, it is requested to select an action serving as the subject of turn consumption for each single turn. Actions that serve as the subject of turn consumption include training, participation in a race, going out, infirmary, etc. The raising-function providing unit 81 accepts selection of an action that serves as the subject of turn consumption via a raising home screen or the like displayed on the display unit 44 and requests the server 20 to compute the result of the selected action. The server 20, upon receiving the request, computes the result of the selected action and transmits the result of the computation to the player terminal 40. The raising-function providing unit 81 causes the display unit 44 to display a display screen corresponding to the computation result received from the server 20.

Furthermore, in this embodiment, a raising target is set in accordance with the kind of the raising subject character, and there are cases where there is an obligatory action, which must forcibly be selected in a prescribed turn for the raising target. The forcible action for the raising target is, for example, participation in a prescribed race or winning a prescribed place as the result of a prescribed race. In this case, in a turn with which a prescribed race associated with the raising target is set, participation in that race is an obligatory action, and it is not possible to select actions for consuming the turn other than participation in the race. As described above, the raising-function providing unit 81 performs control to restrict selection of actions other than an obligatory action in each turn in which selection of the obligatory action is accepted.

Furthermore, the raising-function providing unit 81 performs processing for obtaining factor information to be associated with a character for which raising has been finished from the server 20 and notifying the player of the factor information and, upon approval by the player, registering the character having the factor information associated therewith in the character list in the player management database 51 and the character list in the player-data storage unit 71.

Specifically, the raising-function providing unit 81 performs processing for obtaining factor information to be associated with a character for which raising has been finished from the server 20 and notifying the player of the factor information. For example, the raising-function providing unit 81 transmits a factor acquisition request to the server 20 on the basis of the completion of raising of a character with the raising function and obtains factor information to be associated with the character from the server 20. Then, the raising-function providing unit 81 notifies the player, via the display unit 44, of the factor information obtained from the server 20.

Furthermore, after the notification of factor information to the player, the raising-function providing unit 81 performs processing for accepting an input for reacquiring factor information, making it possible to change the factor information to be associated with the character for which raising has been finished.

Specifically, after the notification of factor information, the raising-function providing unit 81 accepts an input for fixing the factor information and an input for reacquiring factor information, transmits a factor reacquisition request to the server 20 on the basis of the acceptance of the input for reacquiring factor information, and obtains factor information obtained through a relottery from the server 20. In the case where factor information has been reacquired, the raising-function providing unit 81 displays the factor information acquired earlier and the factor information acquired later in a comparable manner for the character for which raising has been finished, allowing the player to select which factor information is to be associated with the character. Then, the raising-function providing unit 81 accepts selection as to which of the factor information acquired earlier and the factor information acquired later is to be associated with the character and fixes the factor information corresponding to the selection result as the factor information to be associated with the character.

Furthermore, on the basis of the fixing of the factor information to be associated with the player, the raising-function providing unit 81 registers the raised character in the character list of the player-data storage unit 71 and transmits a character registration request to the server 20. Upon receiving the character registration request, the server 20 registers the raised character corresponding to the character registration request in the character list in the player management database 51.

The battle-function providing unit 82 performs processing for providing the battle function for letting a raised character possessed by the player play a battle in a race with raised characters of other players as well as non-player characters (NPCs). In this embodiment, a permanent battle function and an event battle function are provided as the battle function.

The permanent battle function is a battle function that is available without any limit concerning a period. Three kinds of races are available for the player, namely, team stadium, daily race, and daily legend race.

The team stadium is a battle function with which the player configures five teams by selecting three characters for each from the raised characters possessed by the player for five kinds of distance categories, namely, short distance, mile, intermediate distance, long distance, and dirt, and playing battles in five kinds of races for the individual distance categories with teams configured by other players. The team to which the character that has won the first place in each of the distance categories belongs wins a victory, and winning three out of the five kinds of races means a victory against the opponent. In the team stadium, stadium points corresponding to the behavior and places of characters in each race are granted, and player ranking is determined on the basis of the total stadium points in the five kinds of races, and rewards corresponding to the ranking are granted.

The daily race is a battle function with which races with different rewards and difficulty levels are prepared for the distance category of mile or intermediate distance and the player selects one character from the raised characters possessed by the player and lets the selected raised character participate in a race and play a battle with non-player characters (NPCs). With the daily race, it is possible to acquire a reward corresponding to the place of the raised character that the player let participate in the race.

The daily legend race is a battle function with which it is possible to acquire a character piece as a reward depending on the result of a race. The character piece is an item that makes it possible to release a character not yet released as a raising subject or to increase the rarity of a released character by consuming a prescribed number of character pieces. With the daily legend race, race conditions are set for individual characters, and the player selects a character for which the player wishes to acquire a character piece, selects a raised character possessed by the player, and lets the selected raised character participate in a race. Then, with the daily legend race, when the raised character that the player let participate wins the first place in the race, it is possible to acquire a character piece for the character corresponding to the participated race.

In the case where the player has determined participation with the permanent battle function including the team stadium, the daily race, and the daily legend race, the battle-function providing unit 82 transmits a battle result request to the server 20. The server 20 executes a race simulation upon receiving the battle result request from the player terminal 40, and the battle-function providing unit 82 obtains the result of the race simulation from the server 20. At the player terminal 40 having received the result of the race simulation from the server 20, the battle-function providing unit 82 generates a race video based on the result of the race simulation on the basis of the various kinds of data stored in the race-control-data storage unit 73 and causes the display unit 44 to display the generated race video, allowing the player to watch how the race goes.

The event battle function is a battle function that is available during a limited period, in which a battle race event is provided. In the battle race event, a main stage and an extra stage are provided. The battle-function providing unit 82 includes a first-stage control unit 83 and a second-stage control unit 84 as control units for letting the game progress in relation to the battle race event.

The first-stage control unit 83 controls the progress of the main stage, in which the records of each player are evaluated on the basis of rank points, which are accumulated as battles are repeated. Specifically, the first-stage control unit 83 performs processing for accepting an input for selecting three raised characters to participate in a race in the main stage from among the raised characters possessed by the player. Furthermore, the first-stage control unit 83 performs processing for accepting a battle-opponent determining input for requesting the determination of an opponent in the race in the main stage and transmitting a matching request to the server 20 on the basis of the battle-opponent determining input. Furthermore, upon receiving the result of opponent matching from the server 20 in response to the matching request, the first-stage control unit 83 performs processing for accepting a participation determining input for determining participation in a race and transmitting a participation request to the server 20 on the basis of the participation determining input. Furthermore, upon receiving the results of race simulations for the five races constituting one set in response to the participation request from the server 20, the first-stage control unit 83 performs control for making it possible to watch how each of the races goes via the display unit 46 and for displaying the race results and information accompanying the race results (the amount of rank points acquired, the status of the league rank, the content of rewards acquired, etc.) on the display unit 46.

The first-stage control unit 83 includes a battle-balance adjustment unit 85. The battle-balance adjustment unit 85 performs processing for acquiring an event skill in the case where the event parameter has reached the maximum value. Specifically, in the case where a matching request is issued to the server 20 in a situation where the event parameter has reached the maximum value, the battle-balance adjustment unit 85 transmits an event-skill acquisition request to the server 20. At the server 20 having received the event-skill acquisition request, the event-skill determination unit 64 performs a lottery to determine an event skill to be acquired and notifies the player terminal 40 of information concerning the event skill to be acquired. Each event skill has set therefor an invocation condition for effectively exhibiting the effect thereof. In a situation where an event skill has been acquired, before race simulations in the main stage are requested to the server 20, the battle-balance adjustment unit 85 performs control for allowing the player to arbitrarily use an item for satisfying the invocation condition of that event skill.

The second-stage control unit 84 controls the progress of the extra stage, in which players with higher-ranked records in the main stage are allowed to participate and the players allowed to participate play battles. In the extra stage, players are classified, depending on the records in the main stage, into players who participate in races and players who do not participate in races. In the main stage, battles are performed in the format in which five races constituting one race are repeated; whereas in the extra stage, the players allowed to participate play a battle in the format in which only one race is carried out. In the case where the player is allowed to participate in races, during a participation registration period in the extra stage, the second-stage control unit 84 performs processing for accepting an input for selecting three raised characters to participate in each race in the extra stage from among the raised characters possessed by the player. The matching for the race in the extra stage is determined on the basis of the ranking based on the rank points in the main stage instead of random matching. Upon the expiration of the participation registration period, the content of participation registration of raised characters is fixed, and a race simulation is executed by the server 20.

Furthermore, the second-stage control unit 84 performs control for making it possible to watch the battle in the extra stage irrespective of whether or not participation in the race in the extra stage is allowed and making it possible to acquire a reward on the basis of watching the battle. Specifically, the server 20 distributes the result of the matching and the result of the race simulation in the extra stage to the player terminals 40 of all the players, and on the basis of the matching result and the race simulation result received from the server 20, the second-stage control unit 84 performs processing for making it possible to watch how the race in the extra stage goes via the display unit 46 and causing the display unit 46 to display the race result and a reward acquired as a result of watching the race on the display unit 46. Alternatively, the arrangement may be such that, in the extra stage of a battle race event, the second-stage control unit 84 makes it possible to watch the race in the extra stage in the case where an operation for a transition from the home screen to the event top screen has been performed after the start of the race period, while the race simulation result is not transmitted from the server 20 to each player terminal 40 at which an operation for transition to the event top screen has not been performed. In this embodiment, during the holding period of a battle race event, an event icon corresponding to the battle race event is provided in the home screen, and the second-stage control unit 84 determines that an operation for transition to the event top screen has been performed in the case where a tap input on the event icon has been performed. Furthermore, the display mode of the event icon may be changed so that the event icon becomes conspicuous in the home screen by highlighting the event icon in the home screen as the extra stage starts in a battle race event.

Furthermore, the second-stage control unit 84 performs control for accepting an input for selecting, as a rooting subject, an arbitrary raised character from among the raised characters that participate in the race when the player watches the battle in the extra stage and displaying a watching screen in which the raised character selected as the rooting subject is distinguishable. Furthermore, the second-stage control unit 84 performs control for making it possible to acquire a reward on the basis of a selection of a rooting subject, transmitting information indicating the selection of the rooting subject to the server 20 to receive information indicating a reward granted for the selection of the rooting subject from the server 20, and causing the display unit 46 to display the content of the reward acquired.

2. Control Method in this Embodiment

The following describes a control method in this embodiment in the context of an example where a game program in this embodiment is applied to a game application for the player terminal 40 provided in the form of a smartphone.

The game program in this embodiment is configured to be able to provide a plurality of kinds of game functions. The battle function, which is one of the main game functions, makes it possible for a plurality of characters to play a battle in a race. With the battle function, without having to operate characters during the race, it is possible to watch, via the player terminal 40, the result of a race simulation performed on the basis of the statuses of the individual participating characters, etc. Furthermore, in the information processing system 10 to which the game program in this embodiment is applied, a battle race event is provided as an event battle function for a limited period, in which an opponent is matched at the server 20 in response to a request from the player terminal 40 and raised characters registered for participation from the individual player terminals 40 compete in a race.

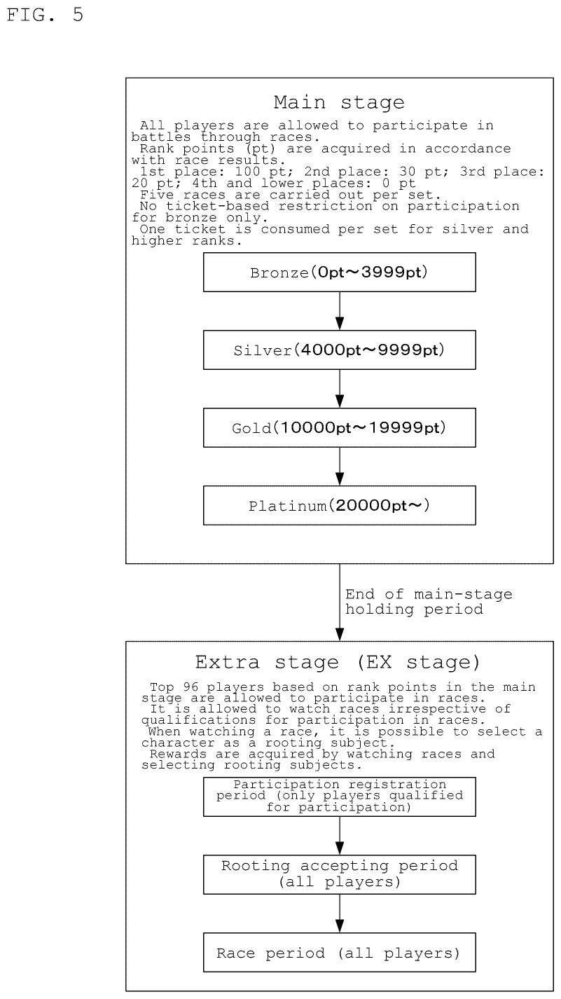

FIG. 5 is a figure showing an overview of how a battle race event is held. As shown in FIG. 5, in each battle race event, a main stage and an extra stage (EX stage) are provided.

In the main stage, a battle is performed in the format in which five races constituting one set are repeated. Rank points are acquired on the basis of the results of the individual races, and the league ranks of players are determined on the basis of the total rank points acquired. For the purpose of matching with a player who serves as an opponent in the main stage, the rank points of the player who requests a battle are referred to. Specifically, a player list is created by extracting players having rank points within a prescribed range of the rank points of the player himself or herself, and a player who belongs to the same league rank as the league rank of the player himself or herself or a league rank close to the league rank of the player himself or herself is determined as an opponent.

As a preparation for playing a battle in the main stage, the player is required to configure and register a team of three characters from among the raised characters possessed by the player himself or herself. The battle in the main stage is carried out through a race among twelve characters in total, including three raised characters of each of the player who has requested a battle and the player who serves as the opponent, as well as six NPCs.

Regarding the league rank, which is determined on the basis of the total rank points acquired in the main stage, there are four classes, namely, bronze, silver, gold, and platinum. When the total rank points acquired in the main stage satisfy a league-rank promotion condition, the league rank is promoted to the next level, and a rank-up reward is granted. The content of the rank-up reward may vary depending on the league rank after promotion, or the content of the rank-up reward may be fixed irrespective of the league rank after promotion. In the case where a battle has been performed in the main stage, a participation reward, which is a reward for participating in each race, is also granted. The participation reward may vary depending on the race result, and the content of the participation reward may be fixed irrespective of the race result, or the content of the participation reward may vary depending on the league rank to which the player belongs. In this embodiment, as the rank-up reward and the participation reward, an in-game currency, an exchange item (an item necessary for the exchange with a rare item), an item that affects the progress of the game or the progress of a race, etc. are granted.

In the main stage, there may be large classification ranks and small classification ranks for the league rank. The large classification ranks may be defined as bronze, silver, gold, and platinum, and for each of the large classification ranks, a plurality of levels of small classification ranks (bronze 1, bronze 2, . . . , silver 1, silver 2, . . . , etc.) may be provided. Note that small classification ranks need not be provided for some of the large classification ranks. For example, assuming platinum as the top level class, small classification ranks need not be provided therefor. In the case where large classification ranks and small classification ranks are provided, the arrangement may be such that a rank-up reward is granted both in the case where a promotion condition for one of the small classification ranks is satisfied and in the case where a promotion condition for one of the large classification ranks is satisfied or such that a rank-up reward is granted in the case where a promotion condition of only either is satisfied.

In the main stage, it is possible to acquire rank points (pt) depending on the individual places of three raised characters registered for participation by the player himself or herself. In this embodiment, it is possible to acquire 100 pt for the first place, 30 pt for the second place, and 20 pt for the third place. Rank points are 0 pt for the fourth and lower places, and thus it is not possible to acquire rank points for the fourth and lower places. In the case where the three raised characters registered for participation by the player occupy the first to third places in a race, it is possible to acquire 150 pt. That is, it is possible to acquire rank points of 150 pt at most per race. In this embodiment, the rank points that can be acquired on the basis of places are fixed irrespective of the league rank to which the player belongs; however, the rank points that can be acquired may vary depending on the league rank. For example, settings may be made such that the amount of rank points to be acquired depending on the place becomes greater as the league rank becomes higher. Furthermore, although the main stage is arranged such that rank points are cumulatively added as battles through races are repeated, the arrangement may be such that the rank points are decreased on the basis of the place when the place is not good, for example, in the case where the place of one of the raised characters registered for participation by the player himself or herself was the ninth or lower place. With the arrangement in which there are cases where rank points are decreased under a prescribed condition, the arrangement may be such that rank points are decreased in the case where the place of one of the raised characters registered for participation by the player satisfies a decreasing condition in the case where the league rank of the player is a specific rank (e.g., platinum).

Regarding participation in a battle in the main stage, there are cases where one participation ticket is required per set. In the case where the league rank is bronze, there is no participation restriction based on the consumption of a participation ticket, and players who belong to bronze can participate in battles without any limit until they satisfy a condition for promotion to silver. For silver to platinum, it is required to consume one participation ticket per participation in battles constituting one set. Ten participation tickets are granted to each player at a specified timing (e.g., 12:00 every day), and the upper limit of the number of participation tickets that can be possessed is twenty. Note that although it is not allowed to possess more than the upper limit of twenty participation tickets through granting at the specified timing, in the case where participation tickets are acquired as rewards or the like or in the case where participation tickets are distributed as compensation for maintenance, it is allowed to possess more than the upper limit of twenty tickets as far as the participation tickets acquired as rewards or the participation tickets distributed as compensation are concerned.

In the main stage, five races (five times of races) are carried out per set (participation in one battle). Matching is performed so that there are no duplicates among the opponents in the five races. Furthermore, the updating of rank points acquired depending on the race results, as well as the reflection of the result of updating the rank points on the display screen, are performed after displaying all the results of the five races constituting one set on the player terminal 40. Alternatively, the updating of rank points, as well as the reflection of the result of updating rank points on the display screen, may be performed each time the result of one race is displayed on the player terminal 40.

In the main stage, the server 20 performs ranking on the basis of the rank points of individual players, and it is possible to view the top 300 players from each player terminal. For players with the same rank points, the players are sorted by using the times at which the acquisition of rank points was recorded as a condition, and ranks are determined so that the player with an earlier time at which the acquisition was recorded is ranked higher. In the case where the time at which the acquisition of rank points was recorded is also the same, ranks may be determined by sorting players by using player IDs or the like as an additional condition.

Upon the expiration of the holding period (e.g., four days) of the main stage, a transition to the extra stage (EX stage) occurs. At the time of the transition to the extra stage, players who are allowed to participate in the battle in the EX stage and players who are not allowed to participate in the battle in the EX stage are determined on the basis of the ranking based on the rank points at the end of the holding period of the main stage.

The extra stage is a stage in which only high-ranking players in the score ranking in the main stage are allowed to participate in races. In this embodiment, the top 96 players are allowed to participate in battles through races, and players other than the top 96 players are not allowed to participate in battles through races. Each race in the EX stage is held in the format in which only four players, not including NPCs, play a battle. Since four players participate in each race, 24 races in total are carried out in the extra stage, i.e., twelve races (the first race to the twelfth race) for block A and twelve races (the first race to the twelfth race) for block B. Only the players allowed to participate can register for participation in the races in the extra stage. The race conditions (weather and course conditions) in the extra stage, which are determined through lotteries at the time of matching, are not disclosed during the participation registration period and is disclosed after the completion of participation registration of raised characters of individual players after the expiration of the participation registration period.

Each player who participates in a race in the extra stage can acquire a participation reward. In this embodiment, it is possible to acquire, as a participation reward, an event-specific nickname in association with a raised character registered for participation in the race. A player who participates in a race, after watching the race in which the player himself or herself participates, is guided to watch the main race (the eleventh race) of each block. In the case where the player himself or herself participates in the main race, after watching the race in which the player himself or herself participates, the player is guided to watch the main race of the other block.

Players who do not participate in the races in the extra stage can also watch the races in the extra stage and can select an arbitrary participating character as a rooting subject when watching. All the players can select a rooting subject whether or not they are allowed to participate in the races in the extra stage.

The extra stage is arranged such that in the case where an operation for a transition to the event top screen has been performed at the player terminal 40 during a race period, a transition to a screen for watching the race occurs. Each player who has selected a rooting subject can acquire a rooting reward for the selection of the rooting subject after watching the race.

For the extra stage, a participation registration period, a rooting accepting period, and a race period are set.

The participation registration period is related to only the players who are allowed to participate in a race. The participation registration period is a period during which three raised characters to participate in a race can be registered for participation by each player who is allowed to participate in the race. Since information indicating the characters last registered for participation in the main stage by each player who is allowed to participate in the extra stage is recorded in the battle management database 52 on the server 20 side, as long as the characters are not changed during the participation registration period, the raised characters recorded in the battle management database 52 are registered for participation upon the expiration of the participation registration period.

In the rooting accepting period, all the players can view all the participating characters in the first race to the twelfth race for block A and block B and can select one arbitrary character as a rooting subject per race. Each player can acquire a rooting reward once for each of block A and block B. The extra stage may be arranged such that a rooting reward can be acquired for the initial selection of a rooting subject.

In the race period, in the case where an operation for a transition to the event top screen has been performed, rendition for replaying the main race (the eleventh race) for block A is started. After the main race for block A has been watched, rendition for replaying the main race (the eleventh race) for block B is started. After the main race for block B has been watched, a transition to the event top screen becomes possible. A watching reward is granted after each main race is watched, specifically, after the race result of each main race is displayed. Each player who has participated in a race watches the race in which the player himself or herself has participated and then watches the main race or races that the player has not watched. After watching the race in which the player himself or herself has participated, the player can additionally acquire an event-specific name, mentioned earlier, as a participation reward in addition to the watching reward. Note that the participation reward need not be granted at the same timing as the watching reward, and the arrangement may be such that a participation reward is granted in the case where an operation for a transition to the event top screen has been performed after the rooting accepting period in the extra stage.

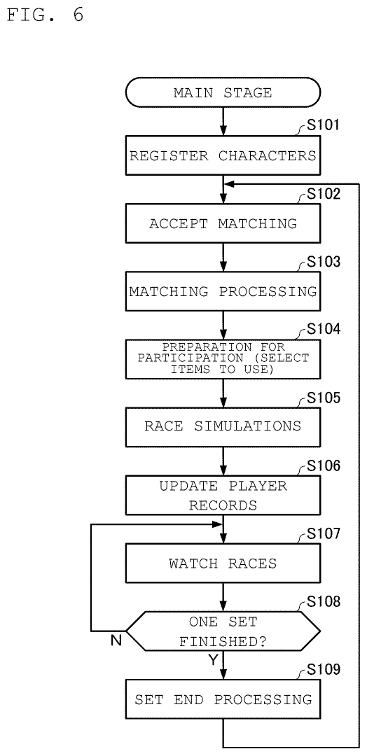

FIG. 6 is a figure showing a flow of progress of the main stage of a battle race event.

First, before starting the main stage, the registration of three raised characters to participate in a race is accepted (step S101). The registration of three raised characters to participate in a race is performed via the event top screen.

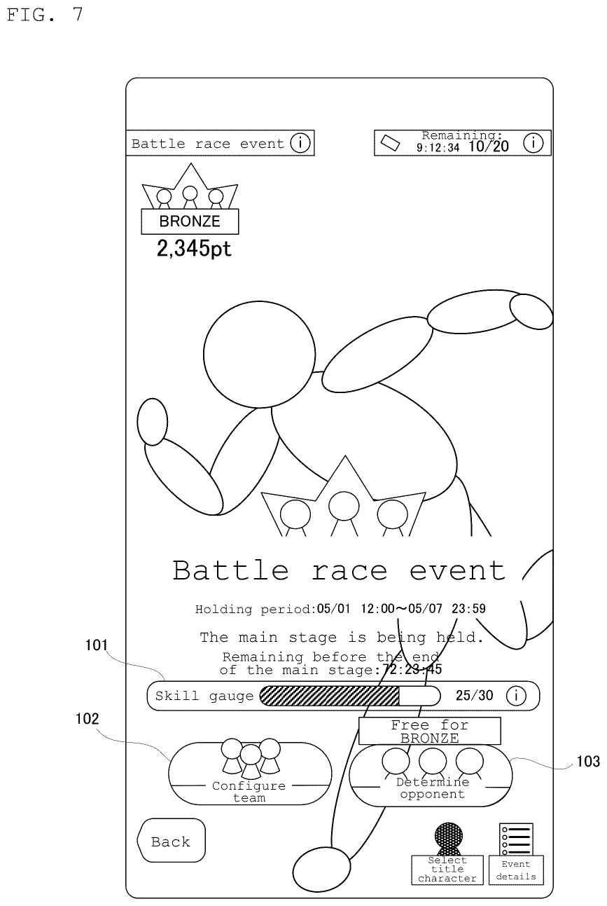

FIG. 7 is an illustration showing an example event top screen displayed. In the event top screen, a skill gauge 101 is displayed. The skill gauge 101 indicates the status of acquisition of the event parameter. This embodiment is arranged such that when the acquisition condition that the event parameter has reached the maximum value is accomplished, special rendition concerning the acquisition of an event skill occurs, and it becomes possible for the three raised characters registered for participation by the player to acquire a buff effect based on the invocation of the event skill. The buff effect based on the invocation of the event skill is effective within the five races constituting one set for which the event skill has been acquired and is reflected in all the five races constituting one set

Furthermore, in the event top screen, a configuration button 102 is provided. When a tap input on the configuration button 102 has been performed, a list of raised characters possessed by the player is displayed, which makes it possible to select raised characters to participate in a race.

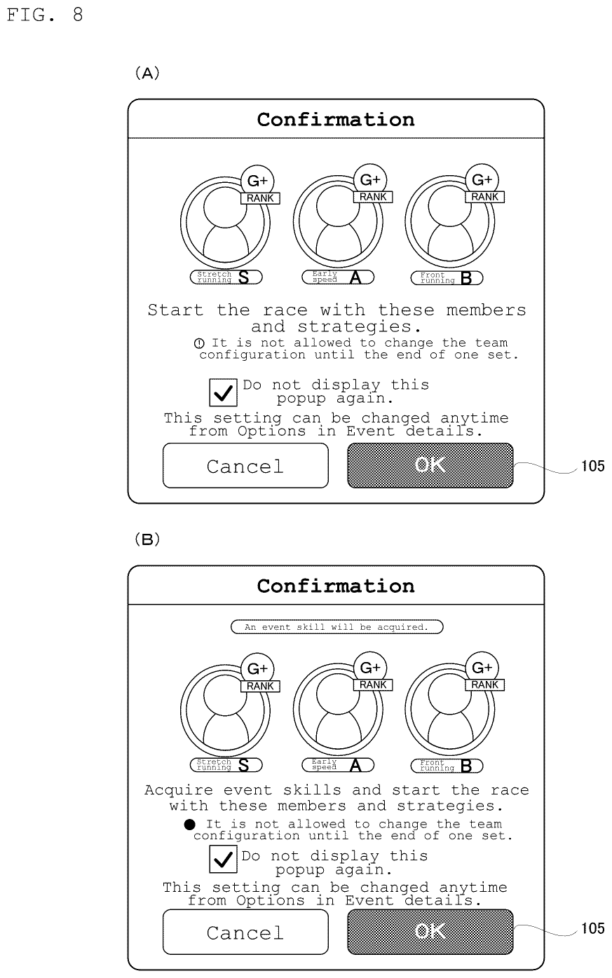

Then, upon the completion of registration of three raised characters to participate in a race, an opponent determining button 103 is enabled in the event top screen to start accepting matching for determining the opponent (step S102). When a tap input on the enabled opponent determining button 103 has been performed in the situation where the event top screen is displayed, a participating-character confirmation dialog is displayed, as shown in part (A) in FIG. 8 and part (B) in FIG. 8. Part (A) in FIG. 8 is an example participating-character confirmation dialog displayed in the case where the event parameter is less than the maximum value, and part (B) in FIG. 8 is an example participating-character confirmation dialog displayed in the case where the event parameter is the maximum value. In this embodiment, depending on the status of acquisition of the event parameter, in the case where the event parameter is the maximum value (e.g., 30), it is indicated in the participating-character confirmation dialog that an event skill will be acquired. When a tap input on an OK button 105 has been performed in the participating-character confirmation dialog, it is determined that a matching input has been performed, and thus a matching request is transmitted from the player terminal 40 to the server 20. Upon receiving the matching request from the player terminal 40, the server 20 performs matching processing for determining an opponent and creating a new battle record (step S103). In the matching processing, a matching ID is assigned to the player at the source of the matching request. Furthermore, a list of players who serve as candidates for the opponent is created, a player who serves as the opponent is extracted from the player list for each of the five races constituting one set, and race IDs for identifying the races to participate in are assigned to the five opponents, thereby creating a battle record for the five races constituting one set. Furthermore, in the matching processing, a gate lotteries for determining participant numbers for twelve participating characters and a condition lottery for determining race conditions (weather and course conditions) are executed, and the result of the gate lottery and the result of the condition lottery are recorded in the battle record.

The matching with an opponent in the main stage may be carried out in different formats depending on the league rank. For example, the matching may be carried out in different formats between the case where the league rank of the player at the source of the matching request is one of bronze to gold and in the case where the league rank of the player is platinum.

First, in the case where the league rank of the player is bronze to gold, normal matching and underdog matching are available for the matching of opponents for five races, and it is possible to adopt normal matching for three races and to adopt underdog matching for the other two races.

With normal matching, with reference to the evaluation score of the raised character having the highest evaluation score among the three raised character registered for participation by the player, it is possible to create a player list from players who have configured raised characters having evaluation scores within a prescribed range including that evaluation score, and to randomly search for an opponent therefrom. The evaluation score of a raised character refers to a numerical index indicating the superiority of the status of the raised character. In this embodiment, the evaluation score of a raised character is calculated on the basis of the performance parameters (speed, stamina, power, spirit, and wisdom) of the raised character and the possessed skills of the raised character. With underdog matching, with reference to the evaluation score of the raised character having the lowest evaluation score among the three raised characters registered for participation by the player, it is possible to create a player list from players who have configured raised characters having evaluation scores within a prescribed range less than that evaluation score, and to randomly search for an opponent therefrom. The range of evaluation scores subject to searching can be set depending on the league rank, and may be the same irrespective of the league rank or may vary depending on the league rank.

Next, in the case where the league rank of the player is platinum, the player whose league rank is platinum is considered as the subject of matching, and without having to refer to the evaluation scores of configured raised characters, it is possible to create a player list only with reference to the league rank. However, the arrangement may be such that in the case where no opponent is found as a result of matching in the case where the league rank of the player is platinum, the subject league rank is lowered to gold in searching for an opponent.

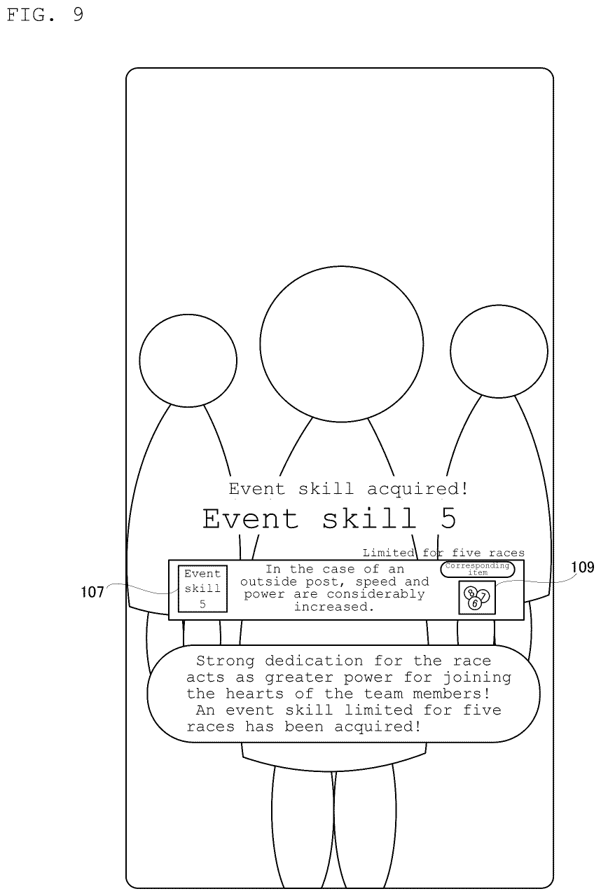

Upon the completion of matching of opponents for the five races constituting one set, the server 20 transmits the matching result including the result of the gate lottery and the result of the condition lottery to the player terminal 40. At the player terminal 40, the opponents for the five races, as well as the raised characters configured by the opponents, are displayed on the display unit 46, and then a participation preparation dialog is displayed, via which an input concerning the use of an item is accepted (step S104). In the case where the event parameter was the maximum value at the time of the matching request, the player terminal 40 also receives the result of acquisition of an event skill together with the matching result from the server 20. Furthermore, before the details of the matching result are displayed, skill acquisition rendition for reporting the result of acquisition of an event skill is executed, as shown in FIG. 9. In the skill acquisition rendition, an icon 107 for the event skill, text for explaining the effect of the event skill, an icon 109 for an item corresponding to the invocation of the event skill (event-skill corresponding item), etc. are displayed.

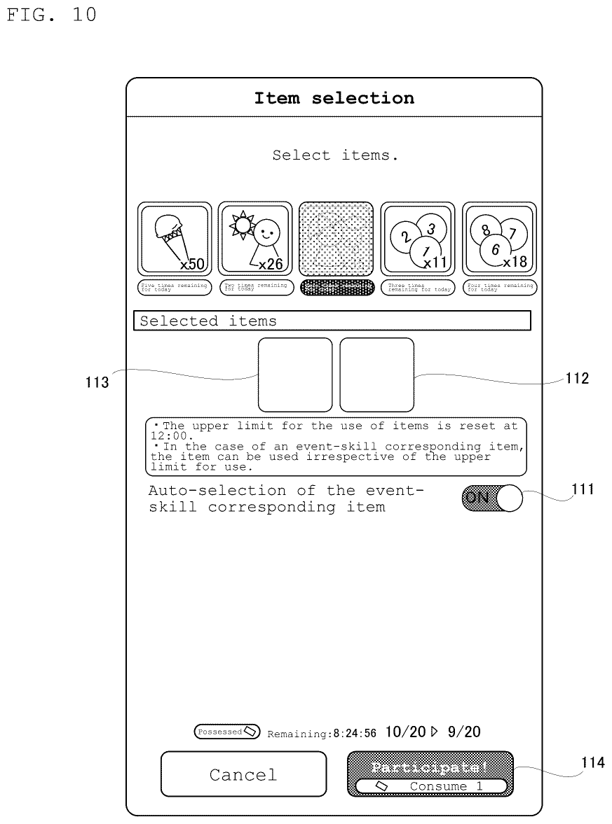

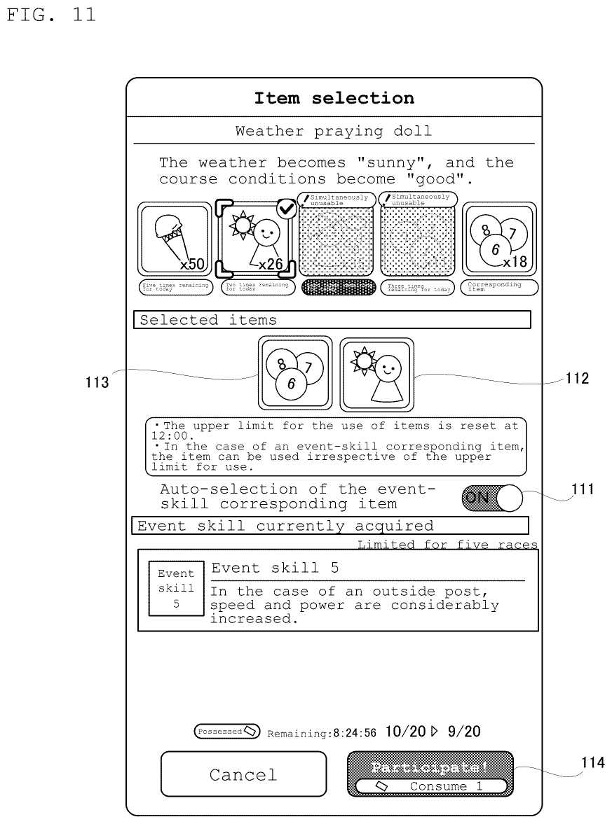

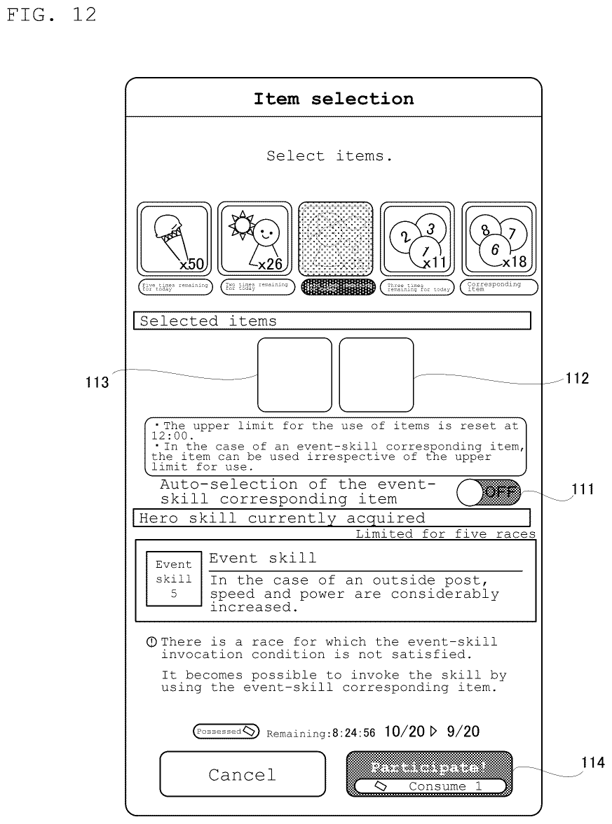

FIGS. 10 to 12 are illustrations showing example participation preparation dialogs displayed. FIG. 10 shows an example participation preparation dialog displayed in a situation where an event skill has not been acquired, and FIGS. 11 and 12 show example participation preparation dialogs displayed in situations where an event skill has been acquired. In the participation preparation dialog, in participating a race, it is possible to select the use of an item for increasing the motivation of a participating character or an item for changing race conditions such as the weather and the course conditions. In this embodiment, it is possible to use two items per set, and the player can arbitrarily decide whether or not to use items. Each item can be used within an upper limit of five times per day, and the upper limit of use is reset to five times at a fixed timing (e.g., 12:00). However, items serving as event-skill corresponding items, which are used in order to satisfy event-skill invocation conditions, can be used even in the case where the upper limit of use has been reached, and the number of times of use is not consumed even in the case where the upper limit of use has not been reached. Furthermore, in the participation preparation dialog, in the case where the use of an item does not work effectively, the icon corresponding to that item is displayed in a grayed-out manner and is controlled so as to prohibit the use thereof. As an example, in the case where the race condition is a sunny weather, an item for changing the weather to sunny does not work effectively and is thus displayed in a grayed-out manner. As another example, in the state where the item for changing the race condition to a sunny weather is selected, an item for changing the race condition to a rainy weather does not work effectively and is thus displayed in a grayed-out manner together with an icon indicating that simultaneous use is not possible. Furthermore, in a situation where an event skill has been acquired, information indicating the acquired event skill is displayed in the participation preparation dialog, and for the icon for the event-skill corresponding item, it is indicated that the item is an event-skill corresponding item in a field for displaying the remaining number of times of use. Furthermore, in this embodiment, an item auto-selection function is provided in the participation preparation dialog, and it is possible to switch the ON/OFF of the item auto-selection function by using an auto-selection-function switching button 111. In the display example shown in FIG. 11, in which the item auto-selection function is ON, the event-skill corresponding item is automatically selected. In the display example shown in FIG. 12, in which the item auto-selection function is OFF, selected-item displaying fields 112 and 113 are blank, and thus it is possible to select the use of arbitrary items.

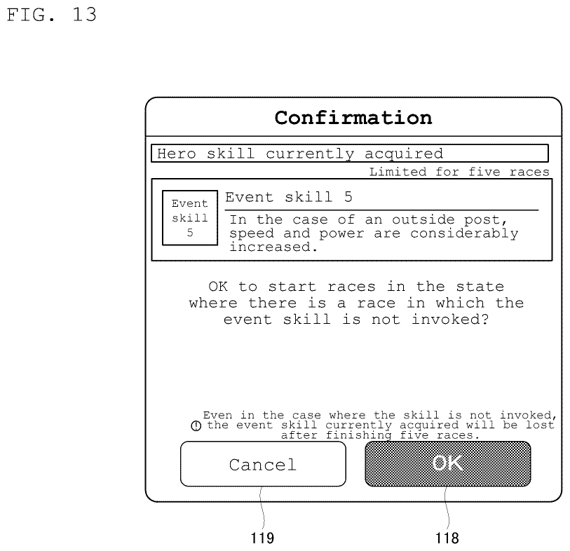

When a tap input on a participation button 114 has been performed in a situation where the participation preparation dialog is displayed, a participation confirmation dialog is displayed to perform final confirmation for participation, as shown in FIG. 13. Note that in the participation button 114 in the participation preparation dialog shown in FIGS. 10 to 12, information indicating the number of participation tickets to be consumed is also displayed. In the case where the league rank of the player is bronze, information indicating that no participation ticket is to be consumed is displayed. In the case where the league rank of the player is silver to platinum, information indicating that one participation ticket is to be consumed is displayed. Furthermore, in the participation confirmation dialog, it is reported whether or not an event skill is to be invoked. For example, as shown in FIG. 13, in the case where an event skill is not to be invoked because the event-skill corresponding item has not been used in a situation where the event skill has been acquired, information is displayed in the participation confirmation dialog to report that the event skill is not to be invoked and that the event skill will vanish after the end of the five races constituting the current set. Furthermore, in the participation confirmation dialog, an OK button 118 and a cancel button 119 are provided. When a tap input on the cancel button 119 has been performed, the participation confirmation dialog is closed, and the participation preparation dialog is displayed. Meanwhile, when a tap input on the OK button 118 has been performed, a participation request is transmitted from the player terminal 40 to the server 20, the participation request including information indicating the content of item use and whether or not an event skill is to be invoked. Upon receiving the participation request, the server 20 performs race simulations for the five races constituting one set (step S105).

In each of the race simulations, on the basis of course information, race conditions, the statuses (speed, stamina, power, spirit, wisdom, and possessed skills) of the twelve participating characters (including six NPCs), etc. associated with the race to participate in, the race development, places, times, etc. are computed, and the race results are recorded in the battle record. The race development here includes movement histories of the individual characters from the start point to the goal point of the course, event occurrence histories (the invocation of skills and the occurrence of accidents) of the individual characters, etc. Furthermore, the server 20 calculates the amount of acquisition of rank points and the amount of updating of the event parameter on the basis of the race result and updates information indicating the records of the player in the battle management database 52.

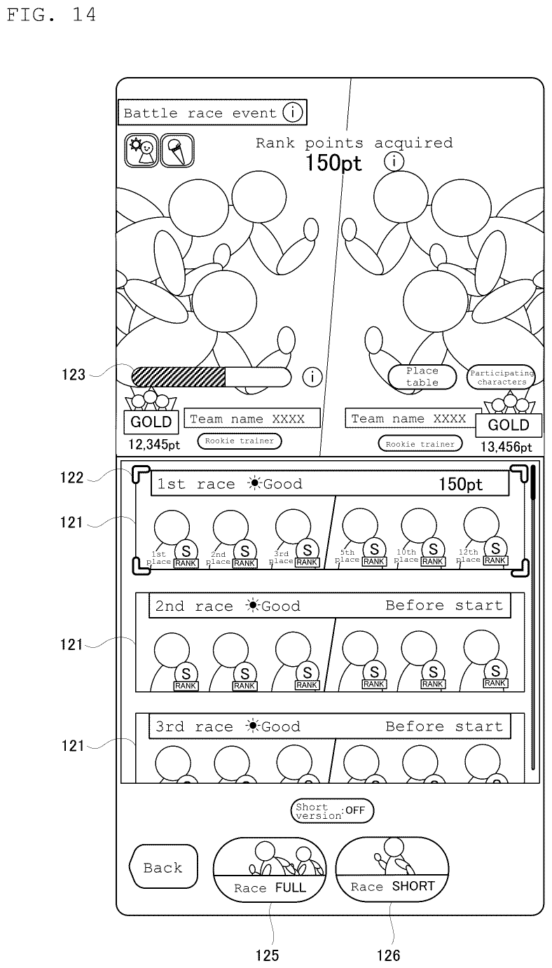

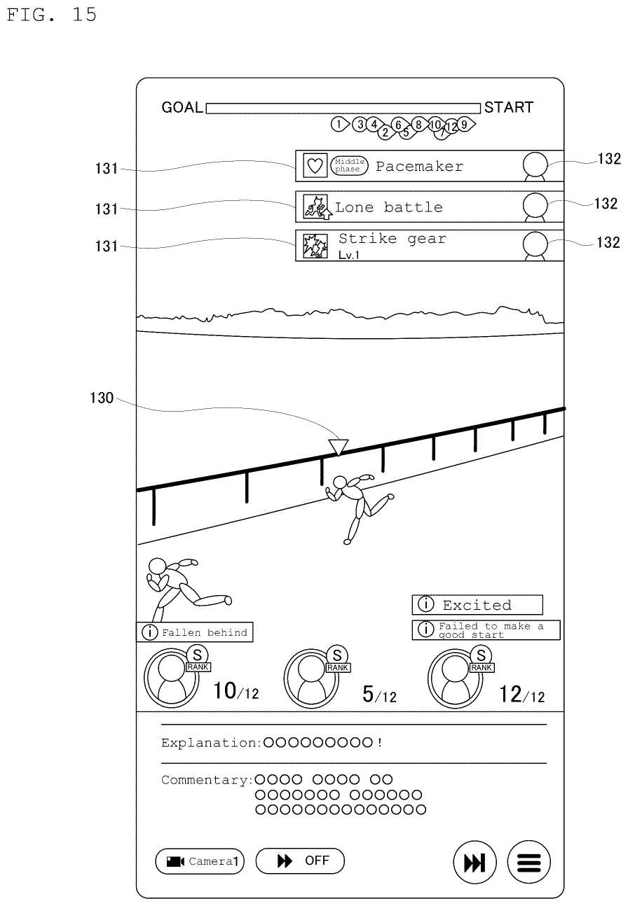

Then, upon the completion of race simulations for the five races constituting one set on the server 20 side, a battle completion response is transmitted to the player terminal 40 at the source of the participation request, the battle completion response including information indicating the simulation results as well as the calculated amount of rank points acquired and the calculated updating amount of the event parameter. At the player terminal 40 having received the battle completion response, the display screen changes to the home screen, via which an input for watching a race and for confirming the race result is accepted, as shown in FIG. 14 (step S106). In the home screen, race icons 121 corresponding to the five races constituting one set are displayed, and it is possible to select a race to watch by performing a tap input on an arbitrary race icon 121. A selection mark 122 is attached to the race icon currently selected. Furthermore, in the home screen, a skill gauge 123 is displayed, which makes it possible to visually recognize the current status of acquisition of the event parameter. Furthermore, in this embodiment, as forms of watching a race, full watching, with which a video for watching is replayed entirely, and short watching, with which a digest version of the video for watching is replayed, are provided. In the home screen, a full watching button 125 and a short watching button 126 are provided. When a tap input on the full watch button 125 has been performed, a video for watching for full watching is replayed. When a tap input on the short watch button 126 has been performed, a video for watching for short watching is replayed. FIG. 15 is an illustration showing one scene of a race video in a video for watching. In the video for watching, an identification mark 130 is attached to a raised character of the player, which makes it possible to identify the raised character that was let participate by the player himself or herself. Furthermore, in the video for watching, in the case where a skill has been invoked, the invoked skill is indicated in a skill icon 131. In the skill icon 131, a character icon 132 is also displayed on the side of a skill name, which makes it possible to identify which characters have invoked the skill. In the case where an event skill has been invoked, the event skill is applied to all the three participating raised characters. Thus, three skill icons 131 for the event skill with the character icons 132 of the participating characters of the player himself or herself are displayed. Alternatively, the arrangement may be such that when an event skill has been invoked, only one skill icon 131 is displayed and character icons 132 for the three characters are displayed side by side in the skill icon 131.

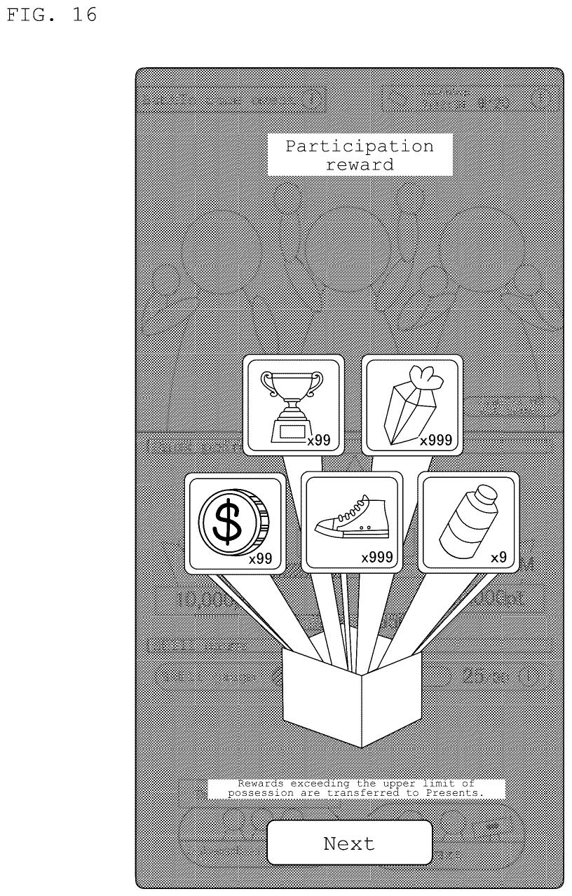

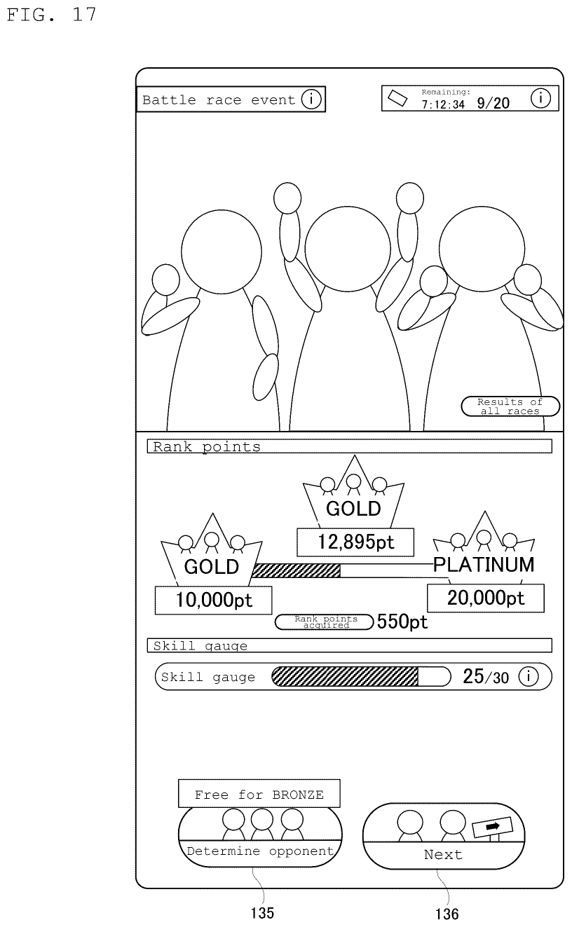

When the watching of the selected race has come to an end, the race result is displayed, and the rank points acquired in the race just watched are reported. Then, the display screen returns to the home screen. When the watching of the five races constituting one set has come to an end (Y in step S108), set end processing is performed (step S109). In the set end processing, the granting of various kinds of rewards, the reflection of the rank points and the event parameter to what are displayed, etc. are performed. For example, after displaying rendition concerning the participation reward acquired for the current one set, as shown in FIG. 16, the display screen changes to a set end screen, in which the status of acquisition of the rank points and the event parameter is reported, as shown in FIG. 17.

Furthermore, in the case where the league rank has been promoted on the basis of the rank points acquired for the current one set, in addition to displaying rendition concerning the participation reward, rank promotion rendition is performed, and the granting of a rank-up reward is reported in the rank promotion rendition.

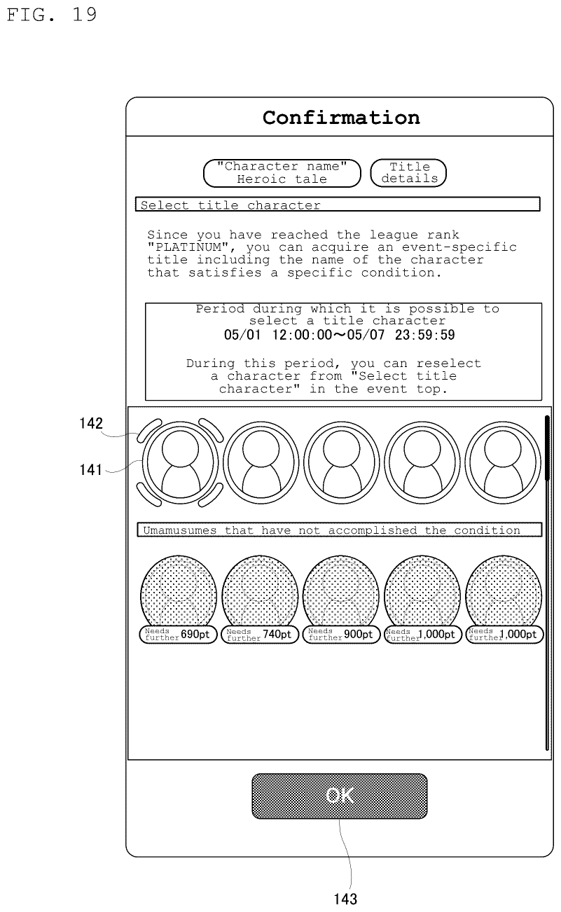

Furthermore, in the case where the league rank has been promoted to platinum which is the top rank, an event-specific title accompanied with the designation of the character name is granted as a top-rank promotion reward. In the case where the event-specific title has been granted, a designated-character selection dialog is displayed, as shown in FIG. 19, which makes it possible to select a character to be designated. In the designated-character selection dialog, characters that satisfy a selection permitting condition and characters that do not satisfy the selection permitting condition are displayed distinctly. In this embodiment, the total amounts of rank points acquired are managed in association with character kind IDs on a per-player basis in the battle management database 52 of the server 20, and for each player whose league rank has reached platinum, it is determined that each character whose total amount of rank points acquired, associated with the character kind ID thereof, has reached a prescribed amount satisfies the selection permitting condition. The selection permitting condition can be defined arbitrarily. As an example, the arrangement may be such that characters that have become released characters in the raising subject list satisfy the selection permitting condition, while characters that have not yet been released do not satisfy the selection permitting condition. As another example, the arrangement may be such that participation flags are set in association with character kind IDs of raised characters that have ever been registered for participation in the main stage in the battle management database 52 and such that characters having participation flags set thereto are considered to satisfy the selection permitting condition, while characters not having participation flags set thereto are not considered to satisfy the selection permitting condition.

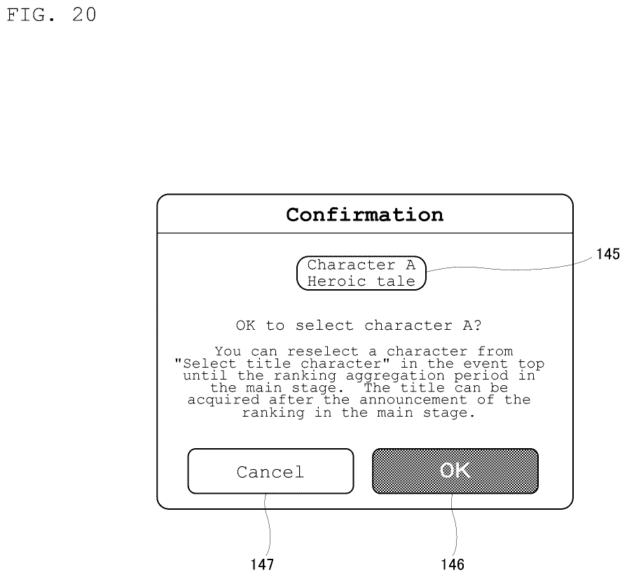

In the designated-character selection dialog, a selection mark 142 is attached to the character icon 141 of a character currently selected among the characters that satisfy the selection permitting condition. When a tap input on an OK button 143 has been performed in the state where the character icon 141 of a character that satisfies the selection permitting condition is selected, a designated-character confirmation dialog is displayed, as shown in FIG. 20. In the designated-character confirmation dialog, an event-specific title 145 is displayed in the state where the character name of the character corresponding to the character icon 141 selected in the designated-character-selection dialog is designated. In the designated-character confirmation dialog, an OK button 146 and a cancel button 147 are provided. When a tap input on the OK button 146 has been performed, the designation of character name for the event-specific title 145 is fixed and is saved in the player-data storage unit 71. Information concerning the designation of the character name for the event-specific title 145 is also transmitted to the server 20 on the basis of the tap input on the OK button 146. At the server 20, the information concerning the event-specific title 145 is also saved in the player management database 51. Furthermore, when a tap input on the cancel button 147 has been performed in the situation where the designated-character confirmation dialog is displayed, the display screen returns to the designated-character selection dialog, which makes it possible to reselect a character.

Furthermore, in the case where the rank-up reward or the event-specific title already mentioned has been granted, after the completion of displaying of rendition concerning these rewards, the display screen returns to the set end screen shown in FIG. 17. In the set end screen, an opponent determining button 135 is provided, making it possible to accept matching for determining an opponent without returning to the event top screen. Note that in the case where the league rank of the player has reached platinum, which is the top rank, it is reported in the set end screen that the league rank has reached the upper limit. Furthermore, in the case where a tap input on a next button 136 provided in the set end screen has been performed, the set end processing is finished, and the display screen returns to the event top screen.

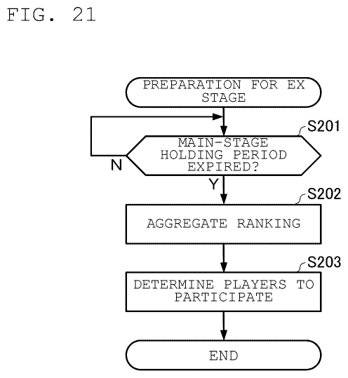

As described above, in the main stage, it is possible to repeatedly play battles of five races constituting one set. When the holding period (e.g., four days) of the main stage has come to an end, preparations for holding the extra stage (EX stage) are executed at the server 20. FIG. 21 is a figure showing a flow of progress concerning preparations for holding the extra stage.

First, when the holding period of the main stage has come to an end (Y in step S201), the ranks of the individual players are fixed (ranking aggregation) on the basis of the total amounts of rank points acquired by the individual players (step S202), thereby determining players who participate in the extra stage. In this embodiment, players ranked 1st to 96th (the top 96 players) on the basis of the total amounts of rank points acquired in the main stage are determined as players who are allowed to participate in races in the extra stage (step S203).

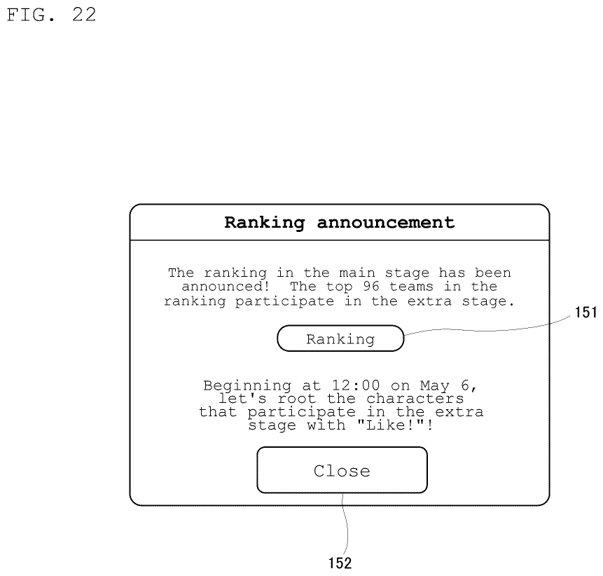

After the completion of the preparations for holding the extra stage on the server 20 side, when an operation for a transition to the event top screen has been performed at the player terminal 40, a ranking announcement dialog is displayed, as shown in FIG. 22. In the ranking announcement dialog, a ranking button 151 is provided. When a tap input on the ranking button 151 has been performed, a ranking acquisition request is transmitted to the server 20. Upon receiving the ranking acquisition request, the server 20 returns ranking data of the top 300 players to the player terminal 40, the ranking data based on the rank points recorded in the battle management database 52. The player can check the top 300 players acquired from the server 20 via the display screen of the player terminal 40. Furthermore, when a tap input on a close button 152 provided in the ranking announcement dialog has been performed, the ranking announcement dialog is closed, and the display screen changes to the event top screen.

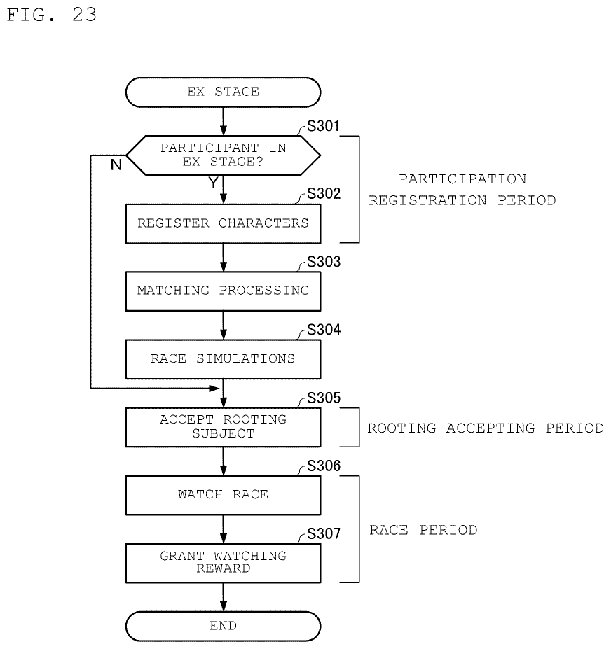

Next, a flow of progress of the extra stage will be described. FIG. 23 is a figure showing a flow of progress of the extra stage in a battle race event.

First, in the extra stage (EX stage), a participation registration period (e.g., 12 hours), a rooting accepting period (e.g., 12 hours), and a race period (e.g., 24 hours) are provided, and players are divided into those who participate in races and those who do not participate in races, as described earlier.

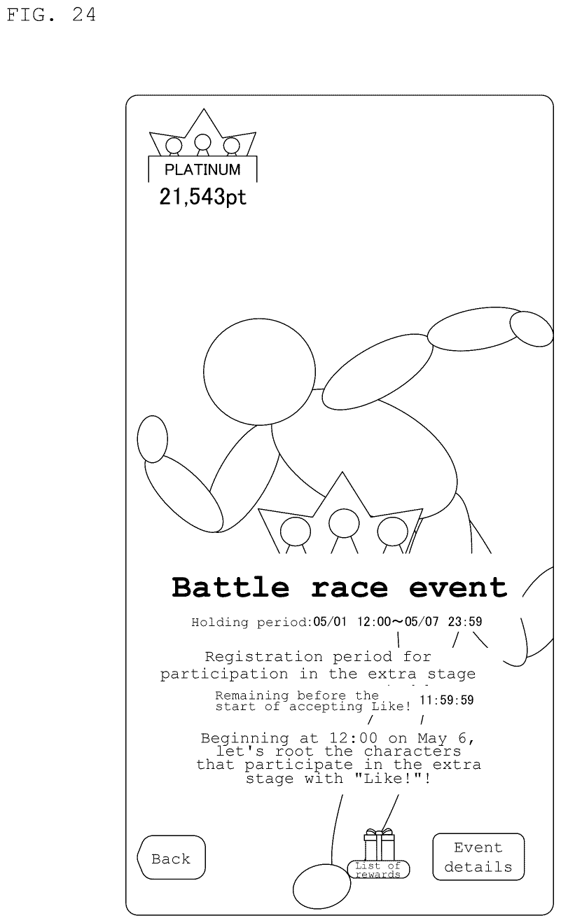

In the participation registration period, in the case where the player does not participate in the extra stage (N in step S301), upon a transition to the event top screen, the date and time of the start of the rooting accepting period are reported, and it is not allowed to advance further from the event top screen, as shown in FIG. 24. Meanwhile, in the case where the player participates in the extra stage (Y in step S301), an event top screen (not shown) in which a configuration button is provided is displayed, similarly to the case shown in FIG. 7. By performing a tap input on the configuration button (a button having a function equivalent to that of the configuration button 102), it is possible to go to a participation registration screen and to register three raised characters to participate in races in the extra stage (step S302).

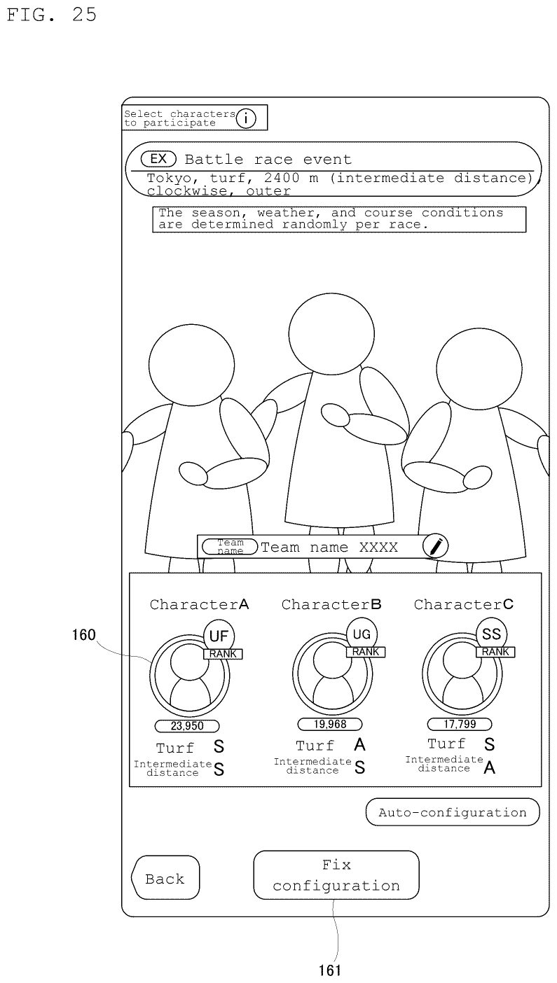

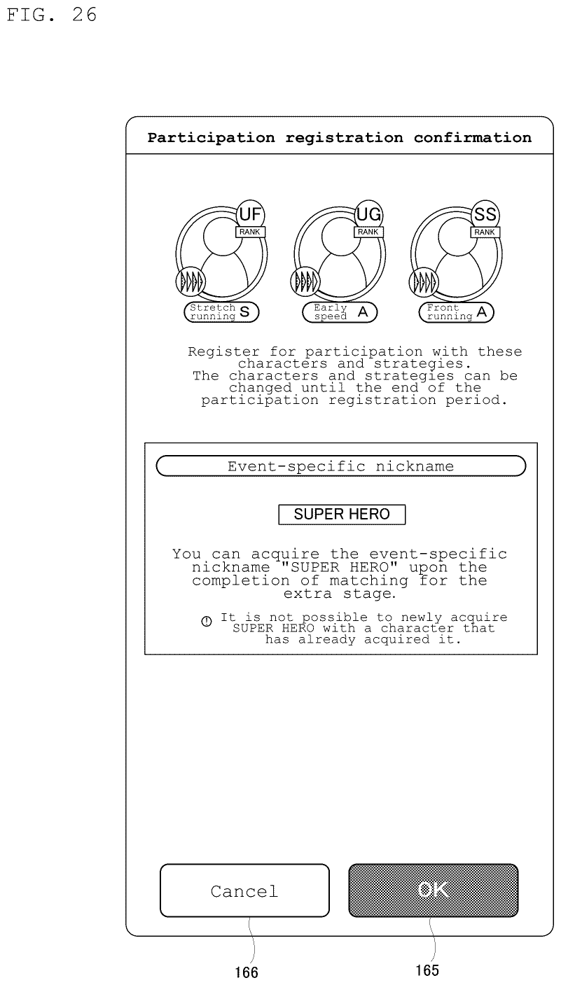

FIG. 25 is an illustration showing an example participation registration screen displayed. In the participation registration screen, the three raised characters that were last let participate by the player in the main stage are displayed in an initially selected state. In the case where a raised character to participate in the extra stage is changed, it is possible to display a list of raised characters that the player himself or herself possesses by performing a tap input on a character icon 160 corresponding to the raised character, and it is possible to change the raised character to participate by selecting another raised character. When a tap input on a configuration fixing button 161 has been performed in the participation registration screen, a participation-registration confirmation dialog is displayed, as shown in FIG. 26. When a tap input on an OK button 165 provided in the participation-registration confirmation dialog has been performed, a participation registration request including the character individual IDs of the three raised characters is transmitted to the server 20. Upon receiving the participation registration request, the server 20 registers the three character individual IDs included in the participation registration request in a battle record for the extra stage, thereby finishing participation registration. Furthermore, in the participation-registration confirmation dialog, it is reported that it is possible to acquire the event-specific nickname “SUPER HERO” as a participation reward for a player who has participated in a race in the extra stage. In this embodiment, it is possible to set a nickname to a raised character. A player who has participated in a race in the extra stage in a battle race event can set the event-specific nickname “SUPER HERO” to a raised characters that has participated in that race. In this embodiment, it is possible to set a nickname to each raised character possessed by the player. The nickname set to a raised character can be displayed together with the character name in a display screen for confirming information concerning the raised character. The nickname set to a raised character can also be displayed to other players registered as friends, other players who participate in the same race by using the battle function, etc. A nickname signifies the accomplishment of a condition for acquiring the nickname in the game. A player can advertise his or her own achievements in the game to other players by using a nickname set to a raised character possessed by the player himself or herself. Furthermore, a nickname is an index indicating achievements in the game and does not basically affect the progress of races or the game. However, with some game functions, it is possible to utilize the possession of a nickname as a determination criterion in processing for extracting raised characters having a prescribed nickname from among the raised characters possessed by the player. Furthermore, in the case where a tap input on a cancel button 166 provided in the participation-registration confirmation dialog has been performed, the participation-registration confirmation dialog is closed, and the display screen returns to the participation registration screen, in which it is possible to reconfigure three raised characters to be registered for participation.

When the participation registration period has expired, matching processing is performed, in which the top 96 players in the main stage are allocated to the 24 races in the extra stage, and which involves a gate lottery for determining participant numbers for the participating characters, as well as condition lotteries for determining race conditions (the weather and the course conditions) (step S303).

The 96 players who participate in the extra stage are divided into 48 players for block A and 48 players for block B and are allocated to twelve races for block A and twelve races for block B. Specifically, groups of four players each are alternately allocated to block A and block B in such a format that the first to fourth ranks are allocated to block A, the fifth to eighth ranks are allocated to block B, and the ninth to twelfth ranks are allocated to block A. In the extra stage, a main race is set for each of block A and block B, and the eleventh race among the twelve races for each block is set as the main race. The players at the first to fourth ranks participate in the main race for block A, and the players at the fifth to eighth ranks participate in the main race for block B. For each block, races to participate in are allocated from players at higher ranks in order of the eleventh race, the tenth race, the ninth race, the twelfth race, the eighth race, the seventh race, . . . , the second race, and the first race.

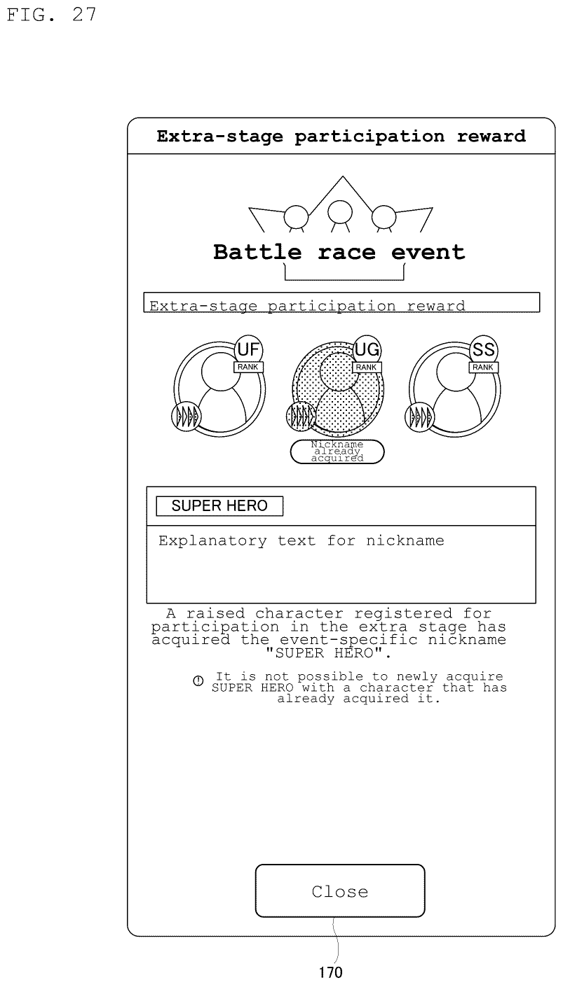

Upon the completion of the matching processing, race simulations are performed for the 24 races in the extra stage (step S304). When a player who participates in a race has performed an operation for a transition to the event top screen at the player terminal 40, an EX-stage participation reward dialog is displayed to report that the event-specific nickname “SUPER HERO” has been acquired, as shown in FIG. 27. When a tap input on a close button 170 provided in the EX-stage participation reward dialog has been performed, the EX-stage participation reward dialog is closed, and the display screen changes to the event top screen.

When the participation registration period in the extra stage has expired and the race simulations by the server 20 have been finished, the rooting accepting period starts, and the acceptance of the selection of a rooting subject via the event top screen is started (step S305).

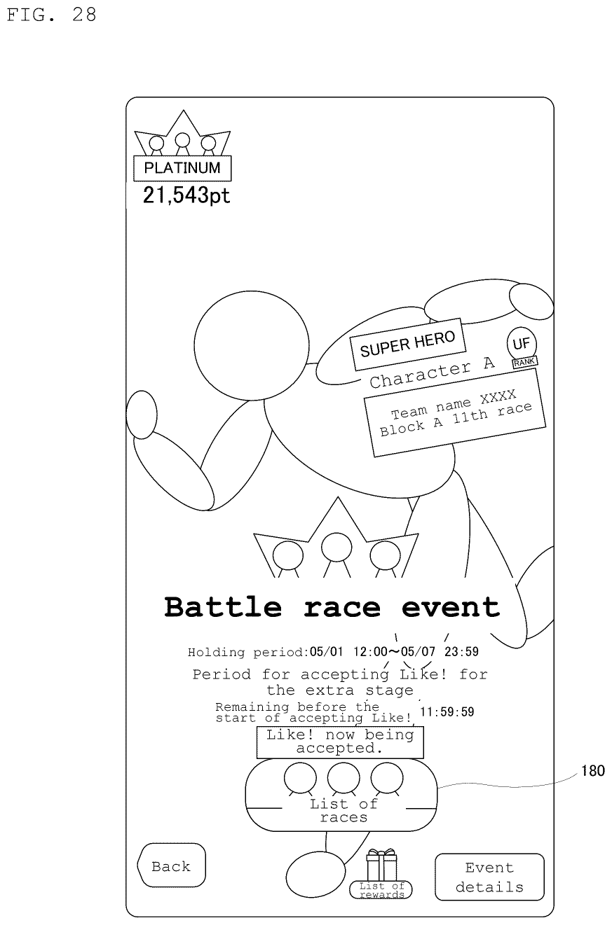

FIG. 28 is an illustration showing an example event top screen displayed in the rooting accepting period. In the event top screen in the rooting accepting period, a race list button 180 with an indication that the selection of a rooting subject is being accepted is provided. When a tap input on the race list button 180 has been performed, a race-list acquisition request is transmitted to the server 20. Upon receiving the race-list acquisition request, the server 20 refers to the battle record for the extra stage, created in the battle management database 52, and transmits race list information including the matching results to the player terminal 40. Upon acquiring the race list information from the server 20, the player terminal 40 displays a race list screen that makes it possible to view participating characters in the 24 races in the extra stage.

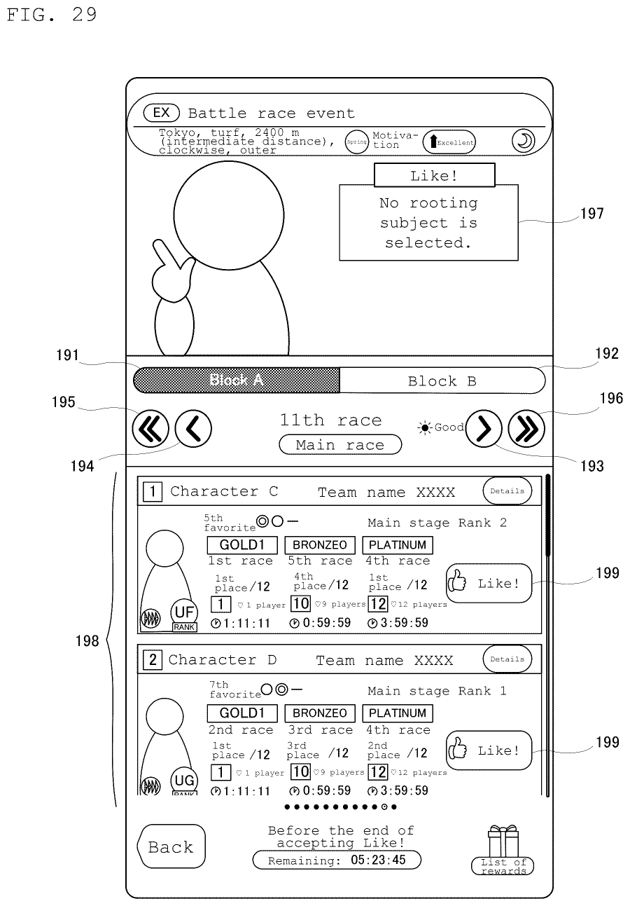

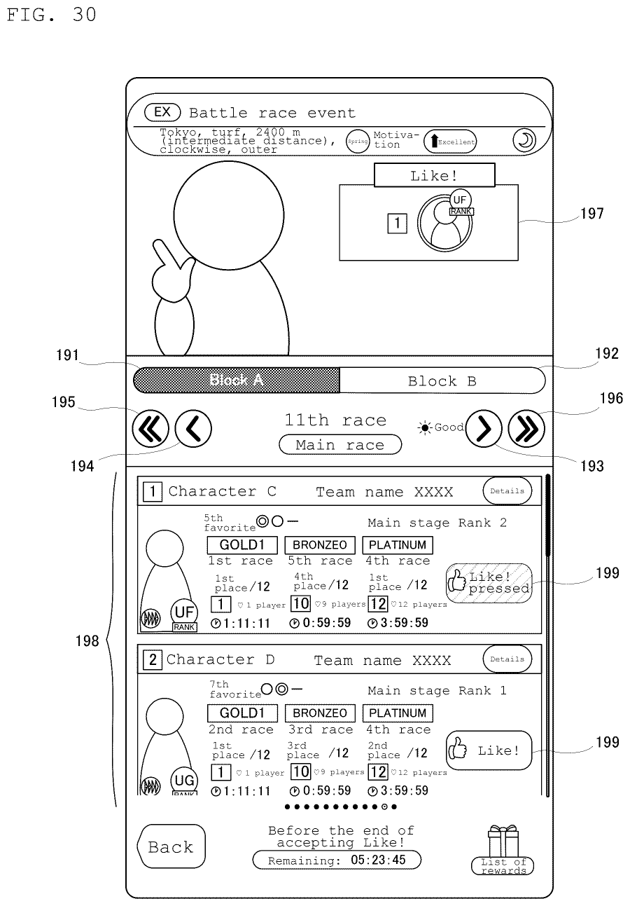

FIGS. 29 and 30 are illustrations showing example race list screens displayed. In the race list screen, it is possible to view twelve participating characters on a per-race basis for each of the first race to the twelfth race for block A and the first race to the twelfth race for block B in the extra stage. The switching of display between block A and block B in the race list screen is possible by performing tap inputs on a block-A tab 191 and a block-B tab 192. The race that is subject to displaying can be switched by using a next button 193 and a back button 194. Furthermore, it is also possible to change the subject of displaying to the first race by using a head button 195 or to change the subject of displaying to the twelfth race by using a tail button 196. In the case where the subject of displaying is a race for which a rooting subject has not been selected, it is indicated in a rooting-subject display area 197 that a rooting subject has not been selected. In the display example shown in FIG. 29, the subject of displaying is the eleventh race for block A, and thus the characters participating in the eleventh race are displayed in a participating-character display area 198. In the participating-character display area 198, various kinds of information, such as a participation history in the main stage, is displayed for each participating character, and a corresponding rooting button 199 is provided for each participating character. When a tap input has been performed on the rooting button 199 corresponding to one of the twelve participating characters for the race currently displayed, the indication for the rooting button 199 on which the tap input has been performed is changed to “selected”, and a character icon 200 of the participating character selected as the rooting subject is displayed in the rooting-subject display area, as shown in FIG. 30. Furthermore, when a tap input has been performed on one of the rooting buttons 199 in order to select a rooting subject, a rooting-subject setting request including rooting-subject selection information is transmitted to the server 20. Upon receiving the rooting-subject setting request, the server 20 records the rooting-subject selection information in association with the player ID in the battle management database 52.

It is also possible to cancel the selection of a rooting subject. When a tap input has been performed again on the rooting button 199 indicating “selected”, the rooting button 199 returns to an unselected state, and the selection as a rooting subject is cancelled. In the case where a tap input on the rooting button 199 has been performed in order to cancel the selection of a rooting subject, rooting-subject cancellation request including rooting-subject cancellation information is transmitted to the server 20. Upon receiving the rooting-subject cancellation request, the server 20 executes processing for cancelling the rooting-subject selection information associated with the player ID, recorded in the battle management database 52.

Furthermore, in this embodiment, irrespective of whether or not to participate in a race in the extra stage, every player can select a participating character per race as a rooting subject in the rooting accepting period. Note that a rooting subject may be selected on a player basis or a team basis (it is considered that three raised characters registered for participation by a single player constitute one team) instead of a character basis. Furthermore, the arrangement may be such that in the case where a rooting subject has been selected in the race list screen, control is performed so as to disable the rooting buttons 199 corresponding to the participating characters other than the rooting subject and to display the rooting buttons 199 in a grayed-out manner.

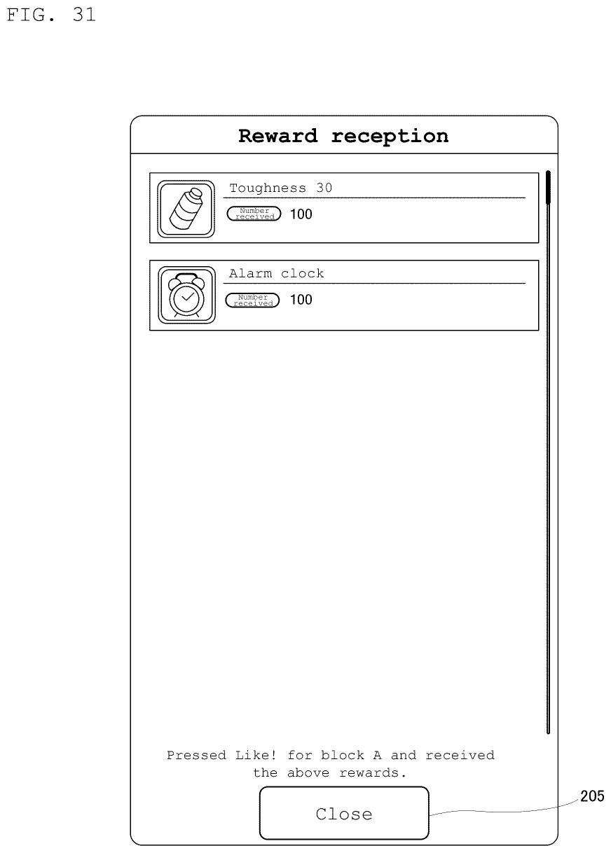

When the rooting accepting period has expired in the extra stage, a rooting reward is granted to each player who has selected a rooting subject for at least one race. For example, after the end of the rooting accepting period, when a player who has selected a rooting subject has performed an operation for a transition to the event top screen at the player terminal 40, the status of selection of a rooting subject associated with the player ID, recorded in the battle management database 52, is checked at the server 20, and control is performed to grant a reward to the player in the case where a rooting subject has been selected. At the player terminal 40 of the player to which the rooting reward has been granted, before a transition to the event top screen, a rooting-reward receiving dialog is displayed as rendition for acquiring the rooting reward, as shown in FIG. 31. When a tap input on a close button 205 provided in the rooting-reward receiving dialog has been performed, the reward receiving dialog is closed, and the event top screen is displayed.

In the extra stage, the race period begins after the end of the rooting accepting period. In the race period, it is possible to watch how the twelve races for each of block A and block B in the extra stage go (step S306), and it is possible to acquire a reward for watching a race (step S307). In this embodiment, at the time of the first transition to the event top screen after the start of the race period, control is performed to guide the player to watch a main race or a race in which the player himself or herself participated in the extra stage.

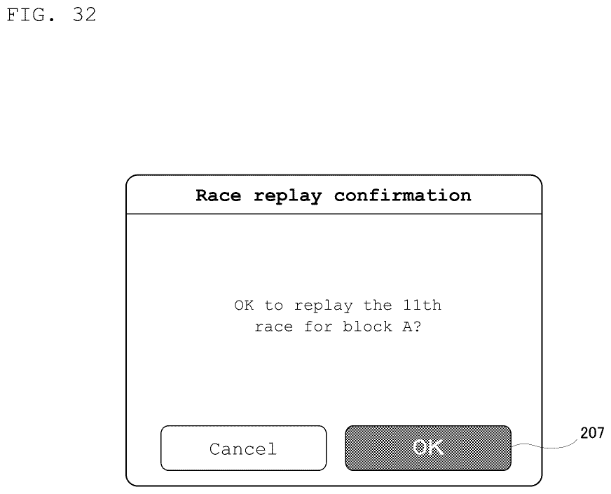

Specifically, in the case where an operation for a transition to the event top screen has been performed at the player terminal 40, a race-replay confirmation dialog is displayed, as shown in FIG. 32. In the race-replay confirmation dialog, a race to watch is displayed. In the case of a player who participates in a race in the extra stage, the race in which the player himself or herself participates is displayed as the race to watch. In the case of a player who does not participate in any race in the extra stage, the main race (the eleventh race) for block A is displayed as the race to watch. When a tap input has been performed on an OK button 207 provided in the race-replay confirmation dialog, a race-information acquisition request including information specifying the race to watch is transmitted to the server 20. Upon receiving the race-information acquisition request, the server 20 transmits the simulation result of the race to watch to the player terminal 40 at the source of the request. At the player terminal 40, a race watching video is created and replayed on the basis of the race simulation result received from the server 20.

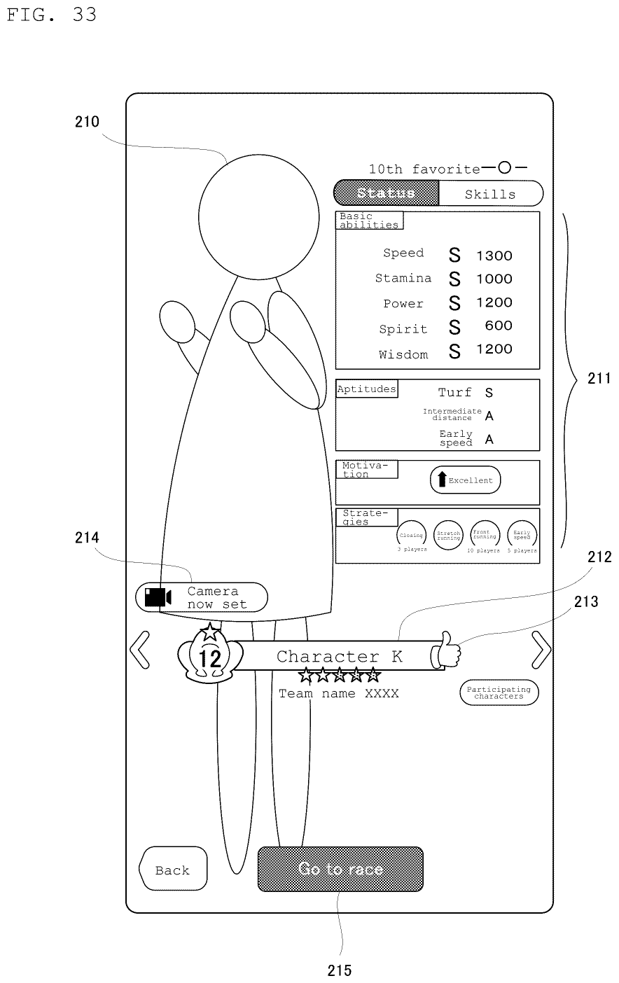

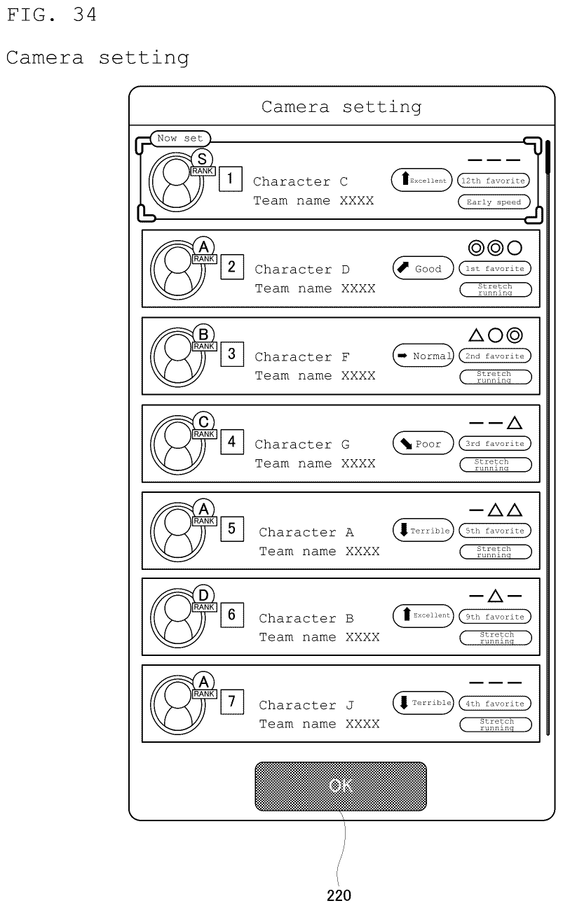

FIG. 33 is an illustration showing one scene of a race watching video of the state immediately before the start in the race watching video. In the state immediately before the start, it is possible to view a 3D model 210 and status information 211 of each participating character one by one, and a rooting mark 213 is attached to a character name indication 212 of the participating character selected as a rooting subject. Furthermore, in the case where the participating character selected as a rooting subject is displayed, an attention subject icon 214 accompanied with the indication “camera is set” is displayed. In this embodiment, in the case of watching a race for which a rooting subject has been selected, a race video is created while performing virtual camera control in which the participating character serving as the rooting subject is set as an attention subject for a virtual camera. In the case of watching a race for which a rooting subject has not been selected, the character set to the first favorite for the race is set as the attention subject of the virtual camera. Furthermore, in a race in which a raised character of the player himself or herself participates, the raised character of the player himself or herself is set as the attention subject of the virtual camera. Note that the setting of the attention subject of the virtual camera in a race video can be arbitrarily changed by the player. Specifically, when a tap input on the attention subject icon 214 has been performed, a camera setting dialog is summoned, as shown in FIG. 34, and it is possible to change the attention subject of the virtual camera by selecting an arbitrary participating character and performing a tap input on an OK button 220.

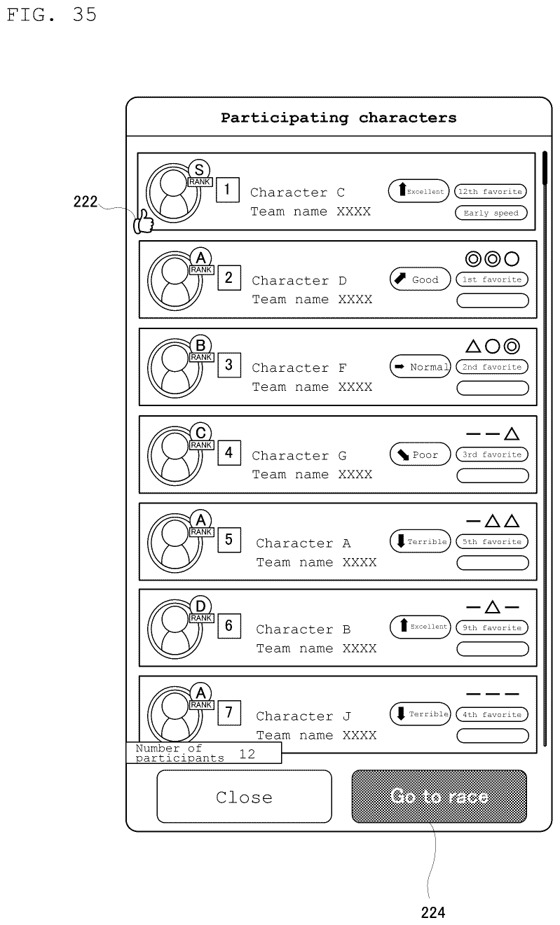

When a tap input on a race start button 215 has been performed in the race watching video of the state immediately before the start, after performing rendition for displaying a list of participating characters, the replay of a race video is started, as shown in FIG. 35. In the rendition screen in which the list of participating characters is displayed, information concerning the participating characters is displayed in a simple form, and a rooting mark 222 is attached to the participating character selected as the rooting subject. When a tap input on a race start button 224 has been performed in the rendition screen in which the list of participating characters is displayed, the replay of a race video is started.

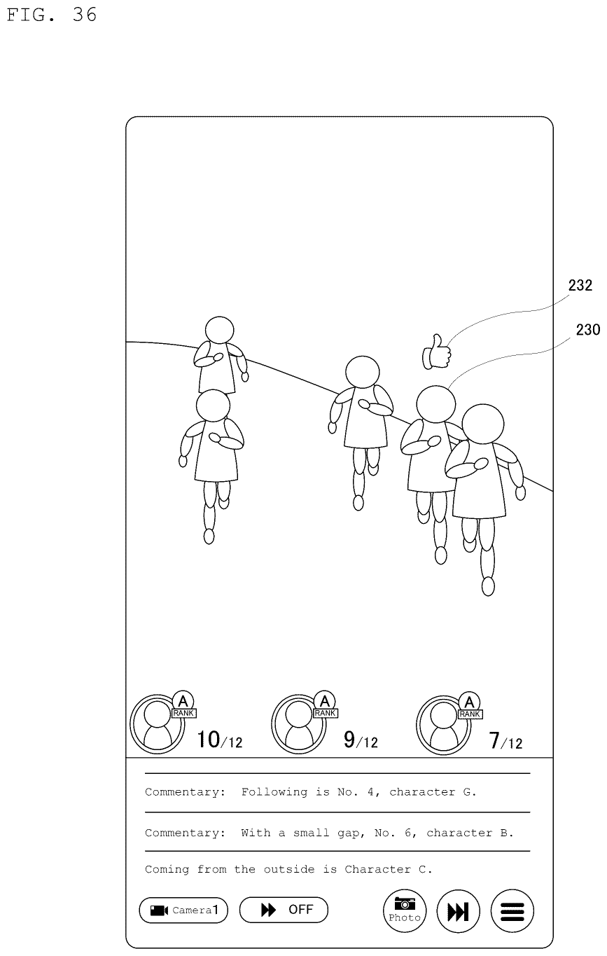

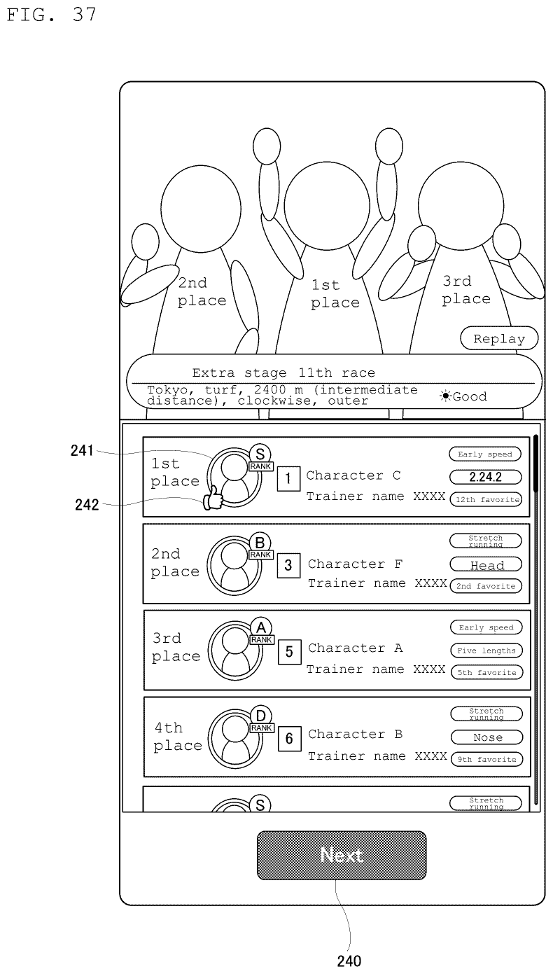

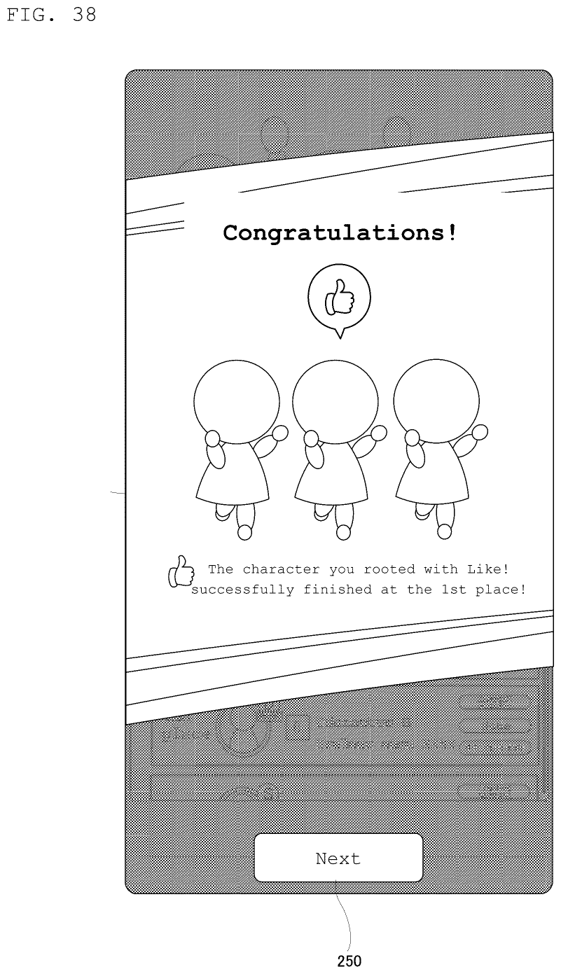

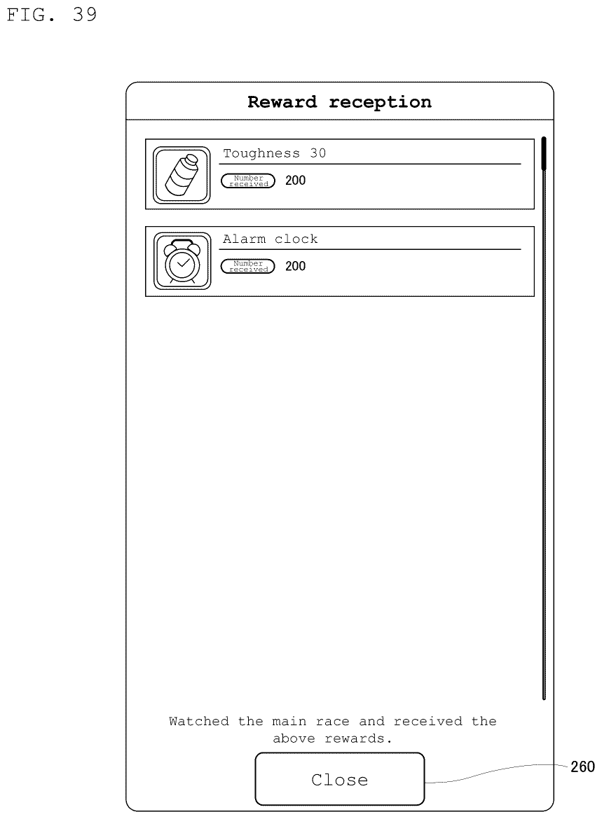

FIG. 36 is an illustration showing one scene in a race video. In the race video, how the race goes is expressed while mainly showing the participating character set as the attention subject. A rooting mark 232 is attached above a 3D model 230 of the participating character set as the rooting subject, which makes it possible to recognize the participating character selected as the rooting subject by the player himself or herself. When the replaying of the race video has been finished, the display screen changes to a race-result display screen, via which it is possible to confirm the places, times, etc. of the individual participating characters, as shown in FIG. 37. In the race-result display screen, a rooting mark 242 is displayed for a character icon 241 of the participating character selected as the rooting subject. In the case where the participating character selected as the rooting subject has won the first place, at the time of the transition to the race-result display screen, rooting-subject victory rendition for reporting that the character selected as the rooting subject finished at the first place is executed, as shown in FIG. 38. When a tap input has been performed on a next button 250 in the screen in which the rooting-subject victory rendition is being executed, the rooting-subject victory rendition is finished, and the race-result display screen is displayed. Then, when a tap input has been performed on a next button 240 provided in the race-result display screen, in the case where there is a main race that has not yet been watched, a race-information acquisition request is transmitted to the server 20, in which the main race is set as the race to watch, and then, the same processing concerning race watching as in the case already described is executed. When the main races for block A and block B have been watched, a watching reward, which is a reward for watching a race in the extra stage, is granted. Specifically, in the case where a tap input has been performed on the next button 240 provided in the race-result display screen for the main race for block B, a watching-reward receiving dialog is displayed, as shown in FIG. 39. The watching reward is granted at the time of the first race watching after the start of the race period in the extra stage, and the watching-reward receiving dialog is displayed only when the watching reward has been acquired. When a tap input on a close button 260 provided in the watching-reward receiving dialog has been performed, the watching-reward receiving dialog is closed. Then, the display screen changes to the event top screen, and the series of processing steps in the race period in the extra stage are finished.

With the information processing system 10 in the embodiment described above, players with high-rank records in the main stage are allowed to participate in races in the extra stage, which makes it possible for the players who have advanced to the extra stage to receive proper evaluations for their abilities. Meanwhile, with the information processing system 10 in this embodiment, it is possible to watch races in the extra stage irrespective of whether or not participation in the extra stage is allowed, and a watching reward can be acquired for watching the races. This can give a motivation for watching the races in the extra stage in order to acquire the watching reward to players who have not advanced to the extra stage. As described above, with the information processing system 10 in this embodiment, it is possible to stimulate motivation for participation of players in a wide variety of categories.

In particular, in each battle race event provided to players by the information processing system 10 in this embodiment, players who participate in the main stage can acquire a rank-up reward, a participation reward, and an event-specific title (top-rank promotion reward). The rank-up reward and the participation reward are items that affect the progress of the game or the in-game currency. Furthermore, in each battle race event provided to players by the information processing system 10 in this embodiment, players who participate in the extra stage can acquire a participation reward (event-specific nickname). While affecting how character information is displayed, whether or not this participation reward has been acquired does not generate advantages/disadvantages among players in the progress of the game. Assuming the case of an arrangement where whether or not to participate in the extra stage considerably affects the subsequent game, players who feel that they will not attain superior records in the main stage become negative about participation in battle race events. With the information processing system 10 in this embodiment, however, by granting only an honorary item as the participation reward in the extra stage, even players who could not participate in races in the extra stage in a battle race event can acquire items for advantageously proceeding with the game. This prevents novice players from losing motivation for participating in battle race events, which makes it possible to gather a sufficient number of participating players in a battle race event. Furthermore, with the event structure that makes it possible to gather a sufficient number of participating players, the number of players who may watch races in the extra stage increases, which makes it easier for advanced players who acquire the participation reward to obtain opportunities for enhancing their own honor.

Furthermore, with the information processing system 10 in this embodiment, when a race in the extra stage is watched, an input for selecting an arbitrary participating character among the characters participating in the race as a rooting subject is accepted, and a race video in which a rooting mark is attached above the participating character is displayed. Thus, the player can enjoy watching the race with an enhanced affection for the participating character selected as the rooting subject.

The arrangement may be such that, the number of selections as a rooting subject (the number of received selections) is aggregated for each participating character in the extra stage, a ranking concerning the number of received selections as a rooting subject is calculated, and the ranking as well as the numbers of received selections as a rooting subject may be displayed at the player terminals 40 of players who watch races in the extra stage (including both players who participate in the races in the extra stage and players who do not participate in the races in the extra stage). Furthermore, a reward such as an item or the in-game currency may be granted to each player who has registered for participation a participating character at a high rank in the ranking of the numbers of received selections as a rooting subject. Furthermore, the arrangement may be such that in the case where a participating character selected by a player as a rooting subject has won a prescribed result (e.g., the first place or the third place or higher) in a race, a reward such as an item or the in-game currency is granted to the player who selected the participating character as the rooting subject.

Furthermore, with the information processing system 10 in this embodiment, since it is possible to acquire a rooting reward on the basis of the selection of a participating character serving as a rooting subject, it is possible to give a positive motivation for a player to select a rooting subject.

Furthermore, with the information processing system 10 in this embodiment, the amount of updating of the event parameter is determined on the basis of an evaluation criterion with which the evaluation becomes higher as the superiority of the race result becomes lower, and in the case where the event parameter has reached the maximum value, it becomes possible to acquire an event skill with which a buff effect advantageous for races is granted, thereby making it possible to suitably adjust the battle balance. Thus, players in a wide variety of categories from novice players to advanced players can enjoy battles through races. In particular, in this embodiment, since it is possible to acquire an event skill through gradual accumulation of the event parameter as a result of repeatedly utilizing races in the main stage, the importance of raising characters does not easily decrease compared with the arrangement in which an effect that works advantageously in the next race is uniformly granted in the case of a defeat in a race. This makes it possible to prevent a reduction in players' motivation for raising characters.

Furthermore, with the information processing system 10 in this embodiment, it is also possible to additionally acquire the event parameter in the case where the result of the race is a narrow defeat. Thus, it is possible to alleviate the sense of loss of a player defeated in a race.

Furthermore, with the information processing system 10 in this embodiment, invocation conditions for event skills to effectively work are set, and players can arbitrarily use event-skill corresponding items relating to the accomplishment of the event-skill invocation conditions. This makes it possible to enhance strategic intricacies of races, thereby enhancing the fun of battles.

Furthermore, with the information processing system 10 in this embodiment, rank points are calculated on the basis of an evaluation criterion with which the evaluation becomes higher as the superiority of a race result becomes higher, and a rank-up reward is granted in the case where a league-rank promotion condition is satisfied on the basis of the total amount of rank points acquired. Thus, it is possible to give players motivation for repeatedly utilizing the event battle function for providing a battle race event.

Furthermore, with the event battle function provided in the information processing system 10 in this embodiment, since race results in the main stage do not affect the records of the opponent player, the arrangement may be such that a plurality of race simulations are performed in accordance with the number of losses in a row of the player. For example, it is possible to perform a lottery as to whether or not a plurality of race simulations are to be performed for the race next to a race resulted in a loss in accordance with the number of losses in a row. For example, the arrangement may be such that a lottery is performed with a winning rate of 10% in the case where the number of losses in a row is one, with a winning rate of 20% in the case where the number of losses in a row is two, with a winning rate of 33% in the case where the number of losses in a row is three, and with a winning rate of 100% in the case where the number of losses in a row is four or greater and such that a plurality of race simulations are performed in the case where the lottery has been won. The number of race simulations in the case where it has been determined to perform a plurality of race simulations may be, for example, set to three. Alternatively, the arrangement may be such that the number of race simulations in the case where it has been determined to perform a plurality of race simulations is set in accordance with the league rank or such that a plurality of race simulations are not performed for a specific league rank (e.g., bronze). Accordingly, since it might impose excessive loads on the server 20 to perform a plurality of race simulations for a rank to which a large number of players belong, the arrangement in which a plurality of race simulations are not performed for a specific league rank makes it possible to alleviate the computation loads of the server 20.

Furthermore, the arrangement may be such that, in the case where a plurality of race simulations are performed for one race, race simulations are finished at the timing when one of the raised characters registered for participation by the player who requested participation has won the first place, and in the case where the raised characters registered for participation by the player who requested participation failed to win the first place as a result of performing all of the plurality of race simulations, the last race simulation is adopted as the race result. Alternatively, a race simulation with the best place may be adopted as the race result. Even in the case where it was not possible to win the first place as a result of performing a plurality of race simulations, it is possible to count the number of losses in a row while considering the result as a loss in one race. For example, in the case where the lottery for a plurality of race simulations is won in a situation with two losses in a row and the race simulations resulted in losses, the number of losses in a row is incremented by one to become three.

Furthermore, there may be provided a function for posting race information (information concerning participating characters, information concerning players who participate in races, race results, the numbers of received selections as a rooting subject, ranking of the numbers of received selections, etc.) in the extra stage in a battle race event to a website or a social networking service (SNS) and guiding users to the website or SNS on which the race information concerning the extra stage is posted via an application relating to the information processing system 10 at the player terminal 40.

Furthermore, regarding the server 20, the matching function and the simulation function may be realized by a single server 20, or these individual functions may be realized by separate servers 20 by distributing the functions to a plurality of servers 20. Furthermore, the arrangement may be such that only a partial function of the matching function and the simulation function is realized by a server 20 separate from the server 20 for the other functions. Furthermore, a plurality of servers 20 having the matching function may be prepared.

Although this embodiment has been described, as an example, in the context of a race game of competing for places as a game in which a plurality of players participate and play a battle, the arrangement may be such that the battle function of the information processing system 10 is provided in other games. The battle function is applicable to any genre of game in which a plurality of players participate and play a battle, such as a combat game, a sport game (baseball game, football game, etc.), an action game, a battle royale game, and a role playing game. Furthermore, the battle format may be any of one vs one, many vs many, and one vs many.

In the case where the control method in this embodiment is applied to a game in the form of a team battle, such as a football game or a baseball game, the arrangement may be such that, as a result of setting a specific team as a rooting subject, rooting marks are displayed with all the player characters that belong to the rooting subject team or a rooting mark is displayed only with a specific player character preset for each team, such as the captain or leader. Furthermore, as for the displaying of a rooting mark in a display screen for watching a match, display control may be performed to switch the player character with which the rooting mark is displayed: for example, the rooting mark is displayed with the player character that possesses the ball in a football game, and the rooting mark is displayed only with the player character in the box or the player character on the mound in a baseball game.

Furthermore, also in the case of a game in which characters individually raised by a plurality of players play a battle against each other, display control may be performed to display a rooting mark, for example, above a character selected as a rooting subject in a screen displayed during the battle.

Furthermore, although a rooting mark is displayed with a rooting subject character in a screen displayed while watching a battle, the arrangement may be such that, in the case where it is possible to view a replay video or a battle highlight video (exciting scenes in the battle: scenes of goals in a football game, scenes of homeruns in a baseball game, scenes of invocation of skills in the battle, etc.) separately from the screen displayed while watching the battle, rooting marks are not displayed in the replay video or the highlight video, avoiding interference with the viewing of the replay video or the highlight video.

Furthermore, although rank points are updated in accordance with places in races in the main stage in a battle race event provided by the information processing system 10 in this embodiment, rank points may be updated in accordance with scores in a match in sport games in which the outcome of a battle is determined on the basis of scores, such as a football game or a baseball game, or rank points may be updated on the basis of the amount of damage given to the opponent in a game in the form of a combat.

1. A program for a game in which a plurality of players participate and play battles, the program causing a computer to function as:
a first-stage control unit that controls the progress of a first stage, in which records of individual players are evaluated on the basis of evaluation scores updated through repeated battles; and
a second-stage control unit that controls the progress of a second stage, in which players with superior records in the first stage are allowed to participate and the players allowed to participate play battles,
wherein the second-stage control unit makes it possible to watch a battle in the second stage irrespective of whether or not participation in the second stage is allowed and makes it possible to acquire a reward on the basis of watching the battle.

2. A program according to claim 1,
wherein when a battle in the second stage is watched, the second-stage control unit accepts an input for selecting, as a subject for a specific indication, an arbitrary game medium from among game media registered by a plurality of players who participate in the battle, and displays a watching screen in which it is possible to identify the game medium selected as the subject for the specific indication.

3. A program according to claim 2,
wherein the second-stage control unit makes it possible to acquire a reward on the basis of having selected the subject for the specific indication.

4. An information processing system for a game in which a plurality of players participate and play battles, the information processing system comprising:
a first-stage control unit that controls the progress of a first stage, in which records of individual players are evaluated on the basis of evaluation scores updated through repeated battles; and
a second-stage control unit that controls the progress of a second stage, in which players with superior records in the first stage are allowed to participate and the players allowed to participate play battles,
wherein the second-stage control unit makes it possible to watch a battle in the second stage irrespective of whether or not participation in the second stage is allowed and makes it possible to acquire a reward on the basis of watching the battle.

5. An information processing method for a game in which a plurality of players participate and play battles, wherein a computer is caused to execute:
a first-stage control step of controlling the progress of a first stage, in which records of individual players are evaluated on the basis of evaluation scores updated through repeated battles; and
a second-stage control step of controlling the progress of a second stage, in which players with superior records in the first stage are allowed to participate and the players allowed to participate play battles, and
in the second-stage control step, it is allowed to watch a battle in the second stage irrespective of whether or not participation in the second stage is allowed, and it is allowed to acquire a reward on the basis of watching the battle.
